(19) United States
(12) Patent Application Publication
(10) Pub. No.: US 2020/0370679 A1
(43) Pub. Date: Nov. 26, 2020

(54) Fluid Conduit Gripping Means

(71) Applicant: Centrica Hive Limited, Windsor (GB)

(72) Inventors: James Crozier, Stow-cum-Quy (GB); Russ Farn, Stow-cum-Quy (GB); Peter Easey, Stow-cum-Quy (GB); Merry Williams, Stow-cum-Quy (GB)

(73) Assignee: Centrica Hive Limited, Windsor (GB)

(21) Appl. No.: 16/756,916

(22) PCT Filed: Oct. 19, 2018
(86) PCT No.: PCT/GB2018/053039

§ 371 Date: Apr. 17, 2020

(30) Foreign Application Priority Data
Oct. 19, 2017 (GB) 1717195.0

(51) Int. Cl. F16L 3/10; B25B 5/14; G01K 1/14; G01K 13/02

(52) U.S. Cl. CPC F16L 3/1066; G01K 13/02; G01K 1/143; B25B 5/147

(57) ABSTRACT

The invention relates to devices for attaching a temperature sensor to a pipe, comprising a first and second jaw for contacting the pipe; and a head slidably mounted between the jaws and having a third engaging portion for contacting the pipe and for retaining a first temperature sensor, the head being moveable between a closed position and an open position, in which the third engaging portion is closer to the first and second jaws in the closed position than in the open position. The jaws are moveable between closed and open configurations, in which the jaws are closer to one another in the closed configuration than in the open configuration. Motion of the jaws and the head is coupled so that the open configuration of the jaws corresponds to the open position of the head and the closed configuration of the jaws corresponds to the closed position of the head. The device may be arranged to bias the first temperature sensor against the pipe in the closed configuration. The invention also relates to a system of markings for indicating to a user whether the device is correctly attached to the pipe, in the form of bands, helixes, etc.

The present invention relates to devices for attaching temperature sensors to fluid conduits and to means for ensuring that devices for gripping fluid conduits are correctly seated on a fluid conduit.

It is often desirable to form attachments to fluid conduits (also known colloquially as pipes). Such conduits may carry hot or cold water, gas, etc. and it may be desirable to alert the public to the contents for safety reasons. More recently, developments in sensing methods have allowed non-invasive flow measurements by measuring proxy variables such as temperature. Such sensors are usually attached to the fluid conduit in order to perform the necessary measurements. These sensors may be left in place for long periods, for example to monitor changes in temperature that may indicate a leak in the system.

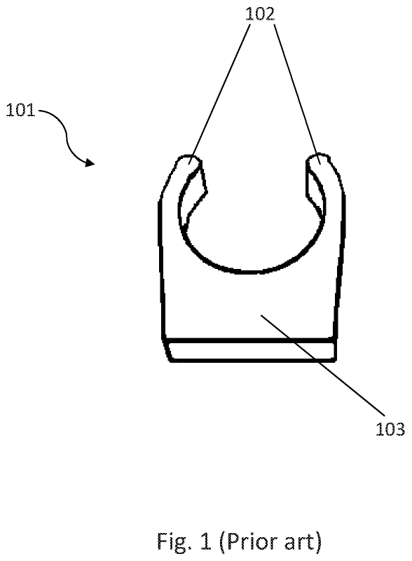

A known means of attaching a pipe to a wall, or of attaching an object to a fluid conduit, is shown in FIG. 1. This clip 101 consists of a pair of jaws 102 arranged to form a generally circular opening shaped and sized to conform to a particular conduit (in this case one with a circular cross-section). The jaws meet at a body 103, through which a screw etc. may be used to attach the clip 101 to a wall (so that a fluid conduit can be mounted to the wall), or a sign or a sensor may be attached to the body 103, for subsequent mounting to the fluid conduit. In order to connect the clip 101 to a fluid conduit, the jaws 102 are pressed against the fluid conduit, causing the jaws 102 to deform outwards to accommodate the conduit. Once the tips of the jaws 102 have passed the widest portion of the conduit, they are able to spring back towards their equilibrium position, thereby gripping the conduit.

There are several drawbacks to such a device. First, the size of the clip must be selected in order to conform to a particular conduit. This requires many different clip types to be carried around by an installation team. In some cases, unusual conduit sizes or poor planning may result in an imperfect fit between the clip and the conduit, which strains the clip and shortens the lifespan. Second, depending on the material used in constructing the clip, a large force may be required to attach the clip to the conduit. In many settings, and especially in domestic environments, it can be difficult to access the desired mounting location, and it may be necessary to attach the clip to the conduit at an awkward angle using only one hand, which can make the attachment difficult. Third, when the clip is used to attach a temperature sensor, it can be important that the sensor measures the temperature of the conduit without affecting that temperature. In order to prevent the clip being an undue thermal burden on the conduit, the contact area between the clip and the conduit should be minimised. By contrast traditional designs tend to result in contact along a large portion of the jaw.

Providing a suitable clip for mounting a sensor is only part of the picture. As noted above, the locations in which sensors are to be mounted on pipes are often awkward to reach and hard to see clearly whether a sensor is correctly mounted. Where a sensor is incorrectly mounted, the sensor may be unable to take measurements at all, or the sensitivity of such measurements may be vastly reduced. For example, where temperature is to be measured, an incorrect installation can leave the temperature sensor in poor or even no thermal contact with the pipe. This in turn leads to either no or very little detected change in pipe temperature, in the sense that the temperature sensor is primarily measuring the ambient temperature, since its contact with the pipe is so poor. Another scenario commonly associated with a poor attachment of the sensor to the pipe is that the clip itself falls away from the pipe, leading to loss or damage of the sensor in addition no useful data being recorded. As noted above, the purpose of the sensor may be to detect or infer flow through the pipe, sometimes with a view to identifying leak conditions. A failure to collect data can therefore lead to a failure to detect a leak, thereby exacerbating damage due to the leak continuing longer than necessary.

Incorrect mounting which may lead to the above errors can include forcing a clip onto a pipe larger than it is designed to accommodate, leading to deformation of the clip, and resulting in the sensor not making contact with the pipe, or not being held firmly against the pipe.

In any of the above scenarios, a user (who is not typically an expert) may call the supplier, or the supplier may notice that the measurements received are erroneous, indicating a missing or poorly installed sensor. This requires the supplier to send a team to re-install the sensor. As noted above, where the sensor is to be installed in hard to reach places, there is no guarantee that the same fault will not occur again.

The present invention aims to address some or all of the drawbacks of such known clips.

Presented herein is a plurality of solutions to at least some of the drawbacks set out above. Each embodiment or aspect represents one of a set of closely related alternative solutions to the problems set out above. Indeed, as will be clear the features presented as part of each embodiment may be applied to other embodiments with ease, and will retain their advantageous characteristics in that new context.

The invention is set out in the appended independent claims with preferred features detailed in the dependent claims.

Disclosed herein is a device for attaching a temperature sensor to a pipe (or pipe), the device comprising: a first jaw having a first engaging portion for contacting the pipe; a second jaw opposed to the first jaw and having a second engaging portion for contacting the pipe; and a head slidably mounted between the jaws and having a third engaging portion for contacting the pipe and for retaining a temperature sensor, the head being moveable between a closed position and an open position, in which the third engaging portion is closer to the first and second engaging portions in the closed position than in the open position; wherein the jaws are moveable between closed and open configurations, in which the first and second engaging portions are closer to one another in the closed configuration than in the open configuration; wherein motion of the jaws and the head is coupled so that the closed configuration of the jaws corresponds to the closed position of the head and the open configuration of the jaws corresponds to the open position of the head; and wherein the device is arranged to bias the first temperature sensor against the pipe in the closed configuration. Such a device provides a convenient connection to a pipe such that the jaws can be arranged in the open configuration (sometimes referred to herein as the second configuration) with the head in the open position (sometimes referred to herein as the second position), such that all three conduit engaging portions are far apart from one another. This allows the device to be fit over a conduit while it is in this open configuration, and then transitioned to the closed, configuration (sometimes referred to herein as the first configuration) to grip the conduit. Suitable means can then be used to retain the device in the closed configuration, thereby holding the device on the conduit. This arrangement results in the jaws and the head moving broadly towards a common point, to cause a gripping action. The biasing of the head against the pipe ensures that the temperature sensor is in good thermal contact with the pipe. In other words, the thermal conductance between the temperature sensor and the pipe is optimised by virtue of the biasing. This biasing presses the temperature sensor firmly against the pipe thereby ensuring that the temperature sensor can detect changes in the pipe temperature. This can be further improved by forming the part of the temperature sensor which is arranged to contact the pipe to be formed from a high thermal conductivity material, for example copper.

In some cases, the device may include means for selectively retaining the jaws in the open configuration, for example a clip, latch, ratchet or strap. In other cases, the head may be biased towards the closed position (sometimes referred to herein as the first position) such that selectively releasing the jaws returns the jaws to the closed configuration. Due to the coupling between the head and the jaws, the biasing of the head in this manner results in the jaws being biased towards one another and implements the gripping motion set out above. Of course, this motion could equivalently be driven by a biasing of the jaws towards the first configuration, which would bring the head to the first position by virtue of the coupled motion. Suitable biasing means include springs, elastic, rigidly deformable materials and the like. Another example of retaining the device in the first configuration is means for retaining the head in a fixed position relative to the jaws. In some examples, selectively releasing the jaws includes applying an inward pressure to the jaws. This provides a convenient manner for triggering the mechanism to allow the head to move towards the closed position.

In some cases, the device includes means for retaining with the jaws in the second configuration. This open configuration (in which the jaws are spaced apart), means that the device is much simpler to use with a single hand, since the jaws can be selectively retained in a wide enough position that they can fit over any conduit of interest, and then released so that the jaws return to the first position (into which they are biased). This allows a user to fit the device over a conduit without exerting any appreciable force, at least in respect of forcing the jaws to open the crude manner required of the known example described above.

In this context, phrases such as “biased towards the first configuration” means that when no force is applied to the device in common usage, the jaws come to an arrangement in which they are closer to one another than they are in the second configuration. As will be clear from the description below, this can be by virtue of an inherent springiness in the jaws resisting deformation, or a more complex interaction may occur in which biasing means are used to drive the transition to the first configuration.

The second jaw configuration will be selected by design to be wide enough to fit over the widest conduit anticipated, which will typically be a feature of the field of applicability and the country (e.g. due to local regulations) in which the installation is desired. For domestic installations on water pipes in Europe, the outer diameter may be as large as 33 mm. Similarly, the first configuration of the jaws can be selected by design to be able to securely grip the narrowest expected conduit, which once again is a feature of field and geography. To further the European domestic water pipe example given above, conduits may be as small as 11 mm outer diameter. These dimensions are examples only, and the skilled person will clearly see that the concepts disclosed herein can be applied to conduits of any size and/or size range with suitable modification and/or scaling of the design. Since the jaws are biased towards the first configuration, once released they will continue to move towards one another until they contact the conduit and grip it.

The head of the device may be slidable between a first position and a second position, in which the third engaging portion is closer to the first and second engaging portions in the first position than in the second position. Allowing the head to slide can provide another degree of freedom to an installation team so that the device can be fit to a variety of conduit sizes. Moreover, this additional degree of freedom can be used to adjust the amount of contact between the device and the conduit, thereby adjusting the thermal contact.

The head may be mounted between the first and second jaws by means of guidance means, wherein the guidance means couples the movement of the head to the movement of the jaws. Such an arrangement provides a secure and stable mounting system for the head, so that the head is retained between the jaws. Additionally, this guidance means can control the motion of the head in such a way that the jaws are biased towards the first configuration. Put another way, the arrangement of the guidance means can be such as to bias the device towards the first configuration.

A convenient example of such a guidance means is one comprising a protrusion arranged to run in a groove, optionally wherein the protrusion is located on the head and a groove is located on at least one of the jaws. In yet further examples, there may be a groove on each jaw and two protrusions on the head, or even four protrusions on the head arranged to run in a pair of grooves located on each jaw. Some examples may have a groove or grooves only on one of the jaws, while the head is more rigidly fixed to the other jaw. In cases where a jaw has two grooves, these may be aligned with one another. The fewer grooves there are, the fewer projections are required to fit into them, and the simpler the construction and assembly of the device can be. A larger number of grooves and corresponding projections can help to improve the stability of the device, thereby helping to make the motion of the head relative to the jaws smoother. In some examples there may be more grooves than protrusions, or vice versa. For example, it may be beneficial to make the head symmetrical so that it can be mounted between the jaws in any configuration, since this can simplify the manufacturing process. This means that, in the case where only one jaw has grooves (or protrusions), then some of the protrusions (or grooves) on the head will not have a corresponding portion to interface with.

In this context, a groove may mean a slit which extends all the way through the jaw, or it may mean a shallow channel in which the protrusion may fit. “Aligned” in this context means that the grooves overlie one another when viewed transverse to the direction of extent of the groove.

The groove or grooves may comprise notches for retaining the protrusion or protrusions so as to fix the position of the head relative to the jaws. This allows the guidance means to also provide a means for retaining the jaws in one of the positions, thereby simplifying construction. In particular the jaws can be held in the second configuration, which allow a used to fit the device over a conduit without the jaws getting in the way.

The guidance means may be configured to draw the jaws towards the closed configuration in the event that the head moves from the open position to the closed position. This can be achieved by forming a groove or grooves such that they do not extend in the same direction as the direction of extent of the jaws for their entire length. For example, where the groove or grooves are on the jaws, they can be angled or curved with respect to the main part of the jaw. Similarly, where the groove(s) are located on the head, the groove(s) can be arranged to not be aligned with the direction in which the head is moveable. In either case, moving the head relative to the jaws will cause the jaws to be drawn together or forced apart.

Additionally or alternatively, each jaw may pivot about a respective pivot point and the means for retaining the jaws in the open configuration comprises a handle on at least one of the first and second jaws. The handles can be used to lever the jaws apart, allowing a user to conveniently widen the jaws. It can be beneficial in these cases for the jaw and handle arrangement to be substantially rigid, to ensure that the full range of motion of the handle translates to a full movement of the jaw.

The handle or handles may comprise an extension of their respective jaws past their respective pivot point. This provides increased leverage to a user. The handles may extend substantially collinearly with the rest of the jaw, or it may form an angle, for example to allow for a greater range of motion.

Additionally or alternatively, the head may be mounted between the jaws by a first clip which grips the first jaw and a second clip which grips the second jaw. The head may further be slidable by the first and second jaws sliding through their respective clips. This provides a simple manner by which the head and the jaws can be connected to one another, while still allowing the head the freedom to slide relative to the jaws.

The point at which each clip grips its respective jaw may provide a fulcrum about which each jaw is deformable to transition between the closed and open configurations. Additionally or alternatively, the jaws may be shaped so that the head being in the closed position holds the jaws in the closed configuration and the head being in the open position holds the jaws in the open configuration. This allows the clips to lever the jaws apart as the head slides relative to the jaws.

Also described herein is a device for attaching a temperature sensor to a pipe, the device comprising: a first jaw having a first engaging portion for contacting the pipe; a second jaw opposed to the first jaw and having a second engaging portion for contacting the pipe; and a head mounted between the jaws having a third engaging portion for contacting the pipe; wherein the jaws are moveable between closed and open configurations (sometimes referred to herein as the first and second configurations respectively), in which the closed and open engaging portions are closer to one another in the closed configuration than in the open configuration; wherein the jaws are biased towards the closed configuration; and wherein the device further comprises means for retaining the jaws in the open configuration. This arrangement allows a user to fit the device over a conduit and lock it in place easily by locking the arrangement of the jaws.

The device may further comprise means for sliding the head relative to the jaws between a closed position and an open position (sometimes referred to herein as the first and second positions respectively), in which the third engaging portion is closer to the first and second engaging portions in the first position than in the second position. This allows a user to slide the head to help grip the conduit. In some cases, the head may be biased towards the first position to assist in this.

The head may be mounted between the jaws by a first clip which grips the first jaw and a second clip which grips the second jaw. The head may further be slidable by the first and second jaws sliding through their respective clips. This provides a simple manner by which the head and the jaws can be connected to one another, while still allowing the head the freedom to slide relative to the jaws.

The point at which each clip grips its respective jaw may provide a fulcrum about which each jaw is deformable to transition between the first and second configurations. Additionally or alternatively, the jaws may be shaped so that the head being in the closed position holds the jaws in the closed configuration and the head being in the open position holds the jaws in the open configuration. This allows the clips to lever the jaws apart as the head slides relative to the jaws.

The means for locking the sliding means comprise a ratchet, clip, pin or other locking system.

Optionally, the means for retaining the jaws in the open configuration comprises a handle on at least one of the first and second jaws. This allows a user to easily force the jaws apart to assist in mounting the device.

Optionally, the head is configured to retain a first sensor for measuring a property of the fluid conduit or of the fluid within the conduit. In some examples the device includes the first sensor. In some examples, the first sensor is retained in the third engaging portion for contacting the fluid conduit. The retention of sensors in one of the contact points is beneficial, as it allows a measurement of a property of the outer surface of the fluid conduit. The contact points can force the sensor into good contact with the surface, which may be particularly beneficial for certain types of sensor. Moreover, mounting the sensor in the head means that the sensor remains between the jaws, which can protect it from accidental damage, and also allows easy inspection of the sensor without removing the device. In some cases, the first sensor may a temperature sensor. Since the device comprises a plurality of contact points, each of which comprises a thermal link, mounting a sensor in one of these contact points obviates the need for a further contact point for the sensor, which reduces the thermal load of the device, in turn benefiting temperature measurements.

The device may further comprise a processing unit. This allows calculations to be performed on signals from any sensors on the device, so that e.g. flow can be detected through the conduit. The processed data can be stored on the device for periodic reading, or transmitted via wired or wireless means to another location, e.g. to alert a user to unexpected flows. The processing unit may be connected to the head via a cable. This allows a separation of the processing and measurement parts of the device. Where temperature is being measured, a processor could heat up and affect the measurement, so providing a separation between these parts can improve the reliability of the data measured by the sensor.

In some examples, there is a second sensor for measuring an ambient property. This provides the ability to take a baseline measurement for comparison with the measured property of the fluid conduit. This may be used for example in flow detection measurements.

The second sensor may be spaced apart from the first sensor, for example it may be located adjacent to the processing unit, where such a unit is present. A separation between the two sensors can help to ensure that the two measurements are independent of one another, that is, that the measurement of the conduit or fluid property is truly a measure of that, unaffected by the ambient property, and that the ambient property is truly an ambient measurement and not affected by the property of the conduit and/or the fluid within the conduit. Where a processing unit is present, this provides a convenient place to locate the second sensor so that it is far enough removed from the first sensor for this to be true. For example, the processing unit can be attached to the rest of the device via a cable, thereby separating the two sensors. As noted above, processing units can generate heat, which may affect the ambient measurement of the second sensor. This can be mitigated by ensuring that, while the second sensor and the processor are located in the same housing, they are located in different portions of this housing.

As noted above, verifying that the sensor has been correctly installed can be a difficult task, particularly where the pipe is in a difficult to reach location. In such cases, the sensor and/or device itself may block the view of the pipe, preventing a user from verifying that the device is correctly attached to the pipe. Consequently, in some examples of the device: may further include the jaws forming part of a body; the head including the first temperature sensor and the first temperature sensor has a cable connected thereto, the cable extending away from the head and through an aperture in the body; wherein the head is slidably mounted to the body such that the head, sensor and cable are slidably moveable relative to the body; and wherein the cable is provided with a marking system for indicating to a user whether the device is correctly attached to the pipe. Since the markings are on the cable, which typically extends away from the pipe, the user's view of the cable (and thus the markings) is usually not blocked by the device itself, thereby allowing a user to use the markings to determine whether the device is correctly seated on the pipe.

In this context, “correctly attached” to the pipe means that the user is able to determine whether the mechanical strength of the connection is sufficient for them to be confident that the device will remain in place, and/or that the sensor is sufficiently engaged with the pipe to allow measurements of sufficient accuracy, reliability or sensitivity to be taken. Putting this another way, it may mean that the user can assess the degree of attachment or quality of attachment of the device to the pipe; that is, is the device mounted square on (at right angles to the pipe, pressing the pipe firmly), correctly engaged (with the sensor in sufficient contact with the correct part of the pipe), in good thermal contact with the pipe, and so forth.

In some examples the marking system indicates to a user the position of the head relative to the body. This can allow a user to determine how far forwards (i.e. towards the pipe) the head has traveled. The person installing the device may have a rough idea of the diameter of the pipe, so be able to determine whether the head has moved far enough forward to contact it. It should be noted that designs which make use of this linear head motion naturally lend themselves to markings which are located a predetermined distance along the cable. For example, the predetermined distance will be at least as far as the distance from the aperture to the part of the sensor which is configured to contact the pipe when the head is as far back (away from the expected pipe position) as it is able to be. The exact distances corresponding to specific head positions (which in turn correspond to specific pipe sizes) will be a feature of the exact design of the device, but it is easy for a skilled person with knowledge of the device design to determine which distances from the end of the cable should be marked to correspond to a given pipe diameter. This can be achieved using geometric calculations, or by calibrating the device with samples of pipe, and marking the cable with the device installed over a test pipe of known diameter.

The device may be arranged to bias the sensor against the pipe, thereby relieving an installer from the need to manually adjust the head position to urge it towards the pipe. In the potentially cramped conditions, this can save the installer time and effort.

Optionally, the marking system comprises a band running at least part of the way around a circumference of the cable. This band can provide a simple indication of whether the head has moved the correct distance to contact the pipe. The band is usually marked in a way which forms a clear contrast with the cable colour. A user can simply look to see whether the band aligns with the aperture or not to determine whether the device is correctly seated on the pipe.

In some examples, there are a plurality of bands running at least part of the way around a circumference of the cable, wherein each of the plurality of bands corresponds to a different pipe diameter. This provides a simple way for the installer to use a universal device (such as the devices described above) to fit to a variety of pipes, since they can readily verify that the device is installed correctly for a given pipe size by checking for alignment with the corresponding marks. The pipe diameters may be selected based on commonly available pipe diameters, taking into account the country in which the property (which houses the pipe) is located, the type of property (commercial or residential, for example) and the type of pipe (hot water, cold water, etc.).

Optionally the or each band comprises a first region indicating optimal attachment of the sensor to the pipe and a second region adjacent the first region indicating acceptable attachment of the sensor to the pipe. In some cases, the second region may represent a tolerance on the measurement, for example where a pipe has been painted, it will be a little thicker than expected, and this may show up as a slight offset from the “optimal” marking position. In other cases, it may reflect manufacturing tolerances in the device, the cable markings or the pipe itself. In yet further examples, it may be that there is an optimal attachment, but small deviations are also acceptable in the sense that the device is unlikely to fall off the pipe, and the sensor is still able to collect data of sufficient quality. In some cases, the second region may have two parts, flanking the first region, meaning that the head may be a little bit further forward or backward than the optimal position, yet each of these is still acceptable. Due to the nature of mounting, the flanking may be asymmetrical, in the sense that the region indicating that the head is too far forward (but is still in an acceptable position) may have a different width (length along the cable) than the width of the region indicating that the head is too far backward (but is still in an acceptable position).

The first region may be coloured in a first colour and the second region may be coloured in a second colour. This may mean a different hue of colour (e.g. green for optimal, yellow for acceptable), a different intensity of colour (e.g. deep green for optimal, faded green for acceptable), a fade from intense colour (at optimal) to the colour of the cable, or indeed more than two regions, each having a different colour (e.g. green for optimal, yellow for acceptable, red for unacceptable). These can allow a user to quickly and intuitively gauge whether the device is correctly attached (and in some cases even how well attached the device is).

The marking system may comprise a series of graduations. For example a linear scale in regularly space metric (mm, cm) or imperial units (inches, fractions thereof). When calibrated correctly, the part of the series of graduations (also known as a graduated scale) which extends out of the aperture and is visible to a user represents a measurement of the distance which the head is offset from its furthest forward position (closest to the expected position of the pipe). In other words, the scale may provide a measurement of the diameter of a pipe being gripped by the device. Where the measurement does not agree with a user's visual estimate of the pipe diameter, the user is conveniently alerted to the fact that the installation has not been correctly performed.

In some cases the graduations emphasise positions of the head relative to the body corresponding to attachment of the device to a pipe having a standard pipe diameter. That is, for example, in situations where pipes typically have outer diameters of 11 mm, 15 mm, 22 mm or 33 mm, the graduated scale may only have markings at these standard numbers. This arrangement makes reading the scale even easier for a user.

In some cases the marking system comprises a helix extending around and along the cable and a marking around the edge of the aperture. The nature of a helix is that it is a line which progresses along both the longitudinal and angular directions. The link between the longitudinal and angular directions means that the angular location (how far around the circumference of the cable the helix is) can be an indicator of how far along the cable that point is. Putting this in more concrete terms, the cable with helical markings can be mounted to the head with a particular orientation, such that the part of the helix at the end of the cable faces upwards (which for simplicity is called 0°). Along the cable leading back from this point, the helix traces out a path which changes both longitudinally and angularly, so that by the time the angular measurement reads say 45°, the longitudinal one may read 5 mm. Assuming that the relationship between angular and longitudinal direction of the path of the helix is fixed (that is, does not depend on angle or longitudinal location), then by the time the path has traveled around the cable once (360°), the longitudinal distance will be 40 mm.

Helixes may loop around a cable multiple times, such that running along the length of the cable (longitudinal direction) bur not around it (keeping angular location fixed), intersects the helix multiple times, once for each full rotation. The distance between two adjacent parts of the helix longitudinally spaced from one another but at the same angular location is called the pitch of the helix—in the above example, the pitch is 40 mm. It is therefore possible to alert a user to the distance which the cable has moved through the aperture by considering the angle at which the helix intersects the aperture. Since every helix H can be written as a function H=f(L,θ), if the exact dependence of the helix on the angle (θ) and the longitudinal distance (L) is known, then a measured angular change (e.g. from the 0° “top” position to a new angle θ) can be converted into a distance moved by the head. This in turn can alert a user to the situation where the distance moved by the does not correspond to a strong grip on a pipe of the expected diameter, and consequently that the device needs adjusting.

The expected angular location of the helix at known or commonly expected pipe diameters can be marked around the edge of the aperture. For example, in the case above where, when the angular measurement reads 45°, the longitudinal one reads 5 mm, a known pipe outer diameter which causes the head to move 10 mm from its furthest forward position may be marked 90° around the aperture from the location where the helix aligns with the aperture when the head is as far forward as possible (a 0 mm displacement). As noted above, the universal devices described herein can be adapted to fit many different pipe sizes. Therefore, some examples have a series of angularly spaced markings around the edge of the aperture, wherein each of the angularly spaced markings corresponds to a different pipe diameter. This provides a quick and easy way for a user to check that the device has correctly attached to a pipe of a given size. In cases where the pitch is fixed (invariant with longitudinal or angular distance) the markings for different pipe sizes may progress around the aperture. In some cases, additional bands may be provided as noted above to distinguish between optimal attachment and acceptable attachment, or to account for variances in measurement accuracy e.g. due to the pipe having been painted.

In some examples, the helix has a varying pitch such that a single longitudinal line on the surface of the cable intersects the helix at a series of positions corresponding to attachment of the device to a pipe having a standard pipe diameter. By varying the pitch, a single line of angular location along the cable (e.g. all parts of the cable having 0° as their angular value) can correspond to a different member of a series of commonly used pipe outer diameters. Since devices usually have to be mounted with a particular orientation relative to a pipe, it is often the case that a particular part of the device will be visible to a user once the device has been installed. By ensuring that common pipe diameters align with the same angular line along the cable, it can be ensured that the user will be able to see the alignment of the markings. This also means that only a single marking is needed around the aperture (in the above example, this would be a single marking at 0°).

It is simple to determine the helix function H=f(L,θ) which achieves this. First, take the set of commonly used pipes in the context, in keeping with the above example, consider the set of diameters 11 mm, 15 mm, 22 mm or 33 mm. Assuming that the head moves the full diameter to accommodate a pipe, then these correspond to the cable moving 11 mm, 15 mm, 22 mm or 33 mm from its furthest forward position. This means that the helix should have a pitch of 11 mm for the first rotation around the cable, a pitch of (15−11)=4 mm for the second rotation around the cable, a pitch of (22−15)=7 mm for the third rotation around the cable and a pitch of (33−22)=10 mm for the fourth rotation around the cable. In this case to assist a user, the helix may additionally have markings (e.g. along the 0° line) to notify the user which pipe diameter that rotation corresponds to. In some cases, the line along which the helix should align with the mark on the casing (at particular head displacements) may be marked on the cable. In others, the helix is arranged such that such a line could be drawn, but it is not expressly marked on the cable.

The body may include an optical element adjacent to the aperture, for viewing the section of cable adjacent to or within the aperture. As noted, the user may be trying to install the device in cramped conditions or at awkward angles. It may help to provide an optical element to assist a user in seeing what the cable looks like at or near to the aperture, so that the markings on the cable are clearly visible. The optical element may work by reflection or refraction. For example an annular reflective surface or an annular lens for refracting light reflected from the surface of the cable to better direct reflected light towards a user, thereby allowing a user to better interpret the markings.

The first and second sensors may measure the same property. This allows the two readings to be compared with one another on a like for like basis.

The head may further comprise stabilisation means to provide lateral support to the device. For example there may be buttress type supports adjacent to the third engaging portion which can prevent twisting of the device relative to the jaws. For example, if the buttresses are aligned with the axis along which the conduit extends, then they can help provide support against the device twisting so that the weight of the device brings the bulk of the device closer to the conduit as the jaws rotate around their points of contact with the conduit, eventually in some cases causing the device to fall from the pipe, risking damage at worst, and even at best rendering the taking of meaningful measurements impossible. When such twisting occurs, the buttresses would be moved closer to the conduit, eventually contacting it and resisting further twisting. Even where the device grips the conduit strongly enough that no twisting occurs under the weight of the device, such support may nevertheless be useful in providing support in the event that the device is accidentally knocked.

Movement between the first and second configurations may include flexing of the jaws in some examples. Additionally or alternatively, movement between the first and second configurations may include pivoting of the jaws. Pivoting the jaws allows for a larger difference between the two configurations than is possible with simple flexing, as overly large flexing can damage the device. Conversely, flexing is a much simpler system than pivoting. In some systems both flexing and pivoting may occur synergistically. In this context pivoting can refer to two separate parts connected by a rotational joint, for example the jaws could be hingedly connected to one another (or each connected to another component in this way). Also within the definition of pivoting in this context is the jaws being connected to one another such that they form a single part, but wherein the joint in configured to deform to allow the jaws to move apart or together. Once more, this principle can be extended to situations in which each jaw is connected to another component in this way.

The exact shape of the jaws in each of the above embodiments can be varied to provide good balance between providing a firm grip and not providing an excessive amount of thermal contact between the conduit and the device. For example, a device which has jaws which have conduit engaging portions which are arcs of circles having a particular radius will grip a conduit of that same radius tightly, but will also have a large contact surface area. Generalised curves such as sections of ellipses, parabolas, Bezier curves, etc. may be used instead to arbitrarily alter the balance between firm grip and thermal contact. Since each embodiment has three contact points (or, more accurately, three lines of contact along the length of extent of the fluid conduit), the area for thermal contact between the device and the conduit is already relatively small.

The head and/or jaws may be formed by moulding methods, or in some cases their manufacture may make use of 3D printing methods. Suitable materials include plastics or metals.

In any of the above examples, the head may be configured to retain a first sensor for measuring a property of the fluid conduit or of the fluid within the conduit. In some examples the device includes the first sensor. In some examples, the first sensor is retained in the third engaging portion for contacting the fluid conduit. The retention of sensors in one of the contact points is beneficial, as it allows a measurement of a property of the outer surface of the fluid conduit. The contact points can force the sensor into good contact with the surface, which may be particularly beneficial for certain types of sensor. Moreover, mounting the sensor in the head means that the sensor remains between the jaws, which can protect it from accidental damage, and also allows easy inspection of the sensor without removing the device. In some cases, the first sensor may a temperature sensor. Since the device comprises a plurality of contact points, each of which comprises a thermal link, mounting a sensor in one of these contact points obviates the need for a further contact point for the sensor, which reduces the thermal load of the device, in turn benefiting temperature measurements.

The device may further comprise a processing unit. This allows calculations to be performed on signals from any sensors on the device, so that e.g. flow can be detected through the conduit. The processed data can be stored on the device for periodic reading, or transmitted via wired or wireless means to another location, e.g. to alert a user to unexpected flows. The processing unit may be connected to the head via a cable. This allows a separation of the processing and measurement parts of the device. Where temperature is being measured, a processor could heat up and affect the measurement, so providing a separation between these parts can improve the reliability of the data measured by the sensor.

In some examples, there is a second sensor for measuring an ambient property. This provides the ability to take a baseline measurement for comparison with the measured property of the fluid conduit. This may be used for example in flow detection measurements.

The second sensor may be spaced apart from the first sensor, for example it may be located adjacent to the processing unit, where such a unit is present. A separation between the two sensors can help to ensure that the two measurements are independent of one another, that is, that the measurement of the conduit or fluid property is truly a measure of that, unaffected by the ambient property, and that the ambient property is truly an ambient measurement and not affected by the property of the conduit and/or the fluid within the conduit. Where a processing unit is present, this provides a convenient place to locate the second sensor so that it is far enough removed from the first sensor for this to be true. For example, the processing unit can be attached to the rest of the device via a cable, thereby separating the two sensors. As noted above, processing units can generate heat, which may affect the ambient measurement of the second sensor. This can be mitigated by ensuring that, while the second sensor and the processor are located in the same housing, they are located in different portions of this housing.

The first and second sensors may measure the same property. This allows the two readings to be compared with one another on a like for like basis.

The head may further comprise stabilisation means to provide lateral support to the device. For example there may be buttress type supports adjacent to the third engaging portion which can prevent twisting of the device relative to the jaws. For example, if the buttresses are aligned with the axis along which the conduit extends, then they can help provide support against the device twisting so that the weight of the device brings the bulk of the device closer to the conduit as the jaws rotate around their points of contact with the conduit, eventually in some cases causing the device to fall from the pipe, risking damage at worst, and even at best rendering the taking of meaningful measurements impossible. When such twisting occurs, the buttresses would be moved closer to the conduit, eventually contacting it and resisting further twisting. Even where the device grips the conduit strongly enough that no twisting occurs under the weight of the device, such support may nevertheless be useful in providing support in the event that the device is accidentally knocked.

Movement between the first and second configurations may include flexing of the jaws in some examples. Additionally or alternatively, movement between the first and second configurations may include pivoting of the jaws. Pivoting the jaws allows for a larger difference between the two configurations than is possible with simple flexing, as overly large flexing can damage the device. Conversely, flexing is a much simpler system than pivoting. In some systems both flexing and pivoting may occur synergistically. In this context pivoting can refer to two separate parts connected by a rotational joint, for example the jaws could be hingedly connected to one another (or each connected to another component in this way). Also within the definition of pivoting in this context is the jaws being connected to one another such that they form a single part, but wherein the joint in configured to deform to allow the jaws to move apart or together. Once more, this principle can be extended to situations in which each jaw is connected to another component in this way.

As noted above, verifying that the sensor has been correctly installed can be a difficult task, particularly where the pipe is in a difficult to reach location. In such cases, the sensor and/or clip itself may block the view of the pipe, preventing a user from verifying that the clip is correctly attached to the pipe.

The present disclosure also relates to a clip for attaching a sensor to a pipe, comprising: a body having at least one engaging portion for gripping the pipe; a head for engaging the pipe; a sensor for measuring a property of the pipe or a fluid within the pipe, the sensor being received in the head and having a cable connected thereto, the cable extending away from the head and through an aperture in the body; wherein the head is slidably mounted to the body such that the head, sensor and cable are slidably moveable relative to the body; and wherein the cable is provided with a marking system for indicating to a user whether the device is correctly attached to the pipe. Since the markings are on the cable, which typically extends away from the pipe, the user's view of the cable (and thus the markings) is usually not blocked by the device itself, thereby allowing a user to use the markings to determine whether the clip is correctly seated on the pipe.

In this context, “correctly attached” to the pipe means that the user is able to determine whether the mechanical strength of the connection is sufficient for them to be confident that the device will remain in place, and/or that the sensor is sufficiently engaged with the pipe to allow measurements of sufficient accuracy, reliability or sensitivity to be taken. Putting this another way, it may mean that the user can assess the degree of attachment or quality of attachment of the clip to the pipe; that is, is the clip mounted square on (at right angles to the pipe, pressing the pipe firmly), correctly engaged (with the sensor in sufficient contact with the correct part of the pipe), in good thermal contact with the pipe, and so forth.

Note that while the markings described below are entirely compatible with the various designs of the devices for attaching temperature sensors to pipes described herein in detail, the use of such markings has applications broader than this. Indeed, any clip for attaching a sensor to pipe of the type set out below represents a suitable scenario to which the markings could be applied.

In some examples the marking system indicates to a user the position of the head relative to the body. This can allow a user to determine how far forwards (i.e. towards the pipe) the head has traveled. The person installing the clip may have a rough idea of the diameter of the pipe, so be able to determine whether the head has moved far enough forward to contact it. It should be noted that designs which make use of this linear head motion naturally lend themselves to markings which are located a predetermined distance along the cable. For example, the predetermined distance will be at least as far as the distance from the aperture to the part of the sensor which is configured to contact the pipe when the head is as far back (away from the expected pipe position) as it is able to be. The exact distances corresponding to specific head positions (which in turn correspond to specific pipe sizes) will be a feature of the exact design of the clip, but it is easy for a skilled person with knowledge of the clip design to determine which distances from the end of the cable should be marked to correspond to a given pipe diameter. This can be achieved using geometric calculations, or by calibrating the clip with samples of pipe, and marking the cable with the clip installed over a test pipe of known diameter.

The clip may be arranged to bias the sensor against the pipe, thereby relieving an installer from the need to manually adjust the head position to urge it towards the pipe. In the potentially cramped conditions, this can save the installer time and effort.

Optionally, the marking system comprises a band running at least part of the way around a circumference of the cable. This band can provide a simple indication of whether the head has moved the correct distance to contact the pipe. The band is usually marked in a way which forms a clear contrast with the cable colour. A user can simply look to see whether the band aligns with the aperture or not to determine whether the clip is correctly seated on the pipe. In some examples the band may run around an entire circumference of the cable, which can allow it to be seen from all angles.

In some examples, there are a plurality of bands running at least part of the way around a circumference of the cable, wherein each of the plurality of bands corresponds to a different pipe diameter. This provides a simple way for the installer to use a universal clip (such as the devices described above) to fit to a variety of pipes, since they can readily verify that the clip is installed correctly for a given pipe size by checking for alignment with the corresponding marks. The pipe diameters may be selected based on commonly available pipe diameters, taking into account the country in which the property (which houses the pipe) is located, the type of property (commercial or residential, for example) and the type of pipe (hot water, cold water, etc.).

Optionally the or each band comprises a first region indicating optimal attachment of the sensor to the pipe and a second region adjacent the first region indicating acceptable attachment of the sensor to the pipe. In some cases, the second region may represent a tolerance on the measurement, for example where a pipe has been painted, it will be a little thicker than expected, and this may show up as a slight offset from the “optimal” marking position. In other cases, it may reflect manufacturing tolerances in the clip, the cable markings or the pipe itself. In yet further examples, it may be that there is an optimal attachment, but small deviations are also acceptable in the sense that the clip is unlikely to fall off the pipe, and the sensor is still able to collect data of sufficient quality. In some cases, the second region may have two parts, flanking the first region, meaning that the head may be a little bit further forward or backward than the optimal position, yet each of these is still acceptable. Due to the nature of mounting, the flanking may be asymmetrical, in the sense that the region indicating that the head is too far forward (but is still in an acceptable position) may have a different width (length along the cable) than the width of the region indicating that the head is too far backward (but is still in an acceptable position).

The first region may be coloured in a first colour and the second region may be coloured in a second colour. This may mean a different hue of colour (e.g. green for optimal, yellow for acceptable), a different intensity of colour (e.g. deep green for optimal, faded green for acceptable), a fade from intense colour (at optimal) to the colour of the cable, or indeed more than two regions, each having a different colour (e.g. green for optimal, yellow for acceptable, red for unacceptable). These can allow a user to quickly and intuitively gauge whether the clip is correctly attached (and in some cases even how well attached the clip is).

The marking system may comprise a series of graduations. For example a linear scale in regularly space metric (mm, cm) or imperial units (inches, fractions thereof). When calibrated correctly, the part of the series of graduations (also known as a graduated scale) which extends out of the aperture and is visible to a user represents a measurement of the distance which the head is offset from its furthest forward position (closest to the expected position of the pipe). In other words, the scale may provide a measurement of the diameter of a pipe being gripped by the clip. Where the measurement does not agree with a user's visual estimate of the pipe diameter, the user is conveniently alerted to the fact that the installation has not been correctly performed.

In some cases the graduations emphasise positions of the head relative to the body corresponding to attachment of the clip to a pipe having a standard pipe diameter. That is, for example, in situations where pipes typically have outer diameters of 11 mm, 15 mm, 22 mm or 33 mm, the graduated scale may only have markings at these standard numbers. This arrangement makes reading the scale even easier for a user.

In some cases the marking system comprises a helix extending around and along the cable and a marking around the edge of the aperture. The nature of a helix is that it is a line which progresses along both the longitudinal and angular directions. The link between the longitudinal and angular directions means that the angular location (how far around the circumference of the cable the helix is) can be an indicator of how far along the cable that point is. Putting this in more concrete terms, the cable with helical markings can be mounted to the head with a particular orientation, such that the part of the helix at the end of the cable faces upwards (which for simplicity is called 0°). Along the cable leading back from this point, the helix traces out a path which changes both longitudinally and angularly, so that by the time the angular measurement reads say 45°, the longitudinal one may read 5 mm. Assuming that the relationship between angular and longitudinal direction of the path of the helix is fixed (that is, does not depend on angle or longitudinal location), then by the time the path has traveled around the cable once (360°), the longitudinal distance will be 40 mm.

Helixes may loop around a cable multiple times, such that running along the length of the cable (longitudinal direction) bur not around it (keeping angular location fixed), intersects the helix multiple times, once for each full rotation. The distance between two adjacent parts of the helix longitudinally spaced from one another but at the same angular location is called the pitch of the helix—in the above example, the pitch is 40 mm. It is therefore possible to alert a user to the distance which the cable has moved through the aperture by considering the angle at which the helix intersects the aperture. Since every helix H can be written as a function H=f(L,θ), if the exact dependence of the helix on the angle (θ) and the longitudinal distance (L) is known, then a measured angular change (e.g. from the 0° “top” position to a new angle θ) can be converted into a distance moved by the head. This in turn can alert a user to the situation where the distance moved by the does not correspond to a strong grip on a pipe of the expected diameter, and consequently that the clip needs adjusting.

The expected angular location of the helix at known or commonly expected pipe diameters can be marked around the edge of the aperture. For example, in the case above where, when the angular measurement reads 45°, the longitudinal one reads 5 mm, a known pipe outer diameter which causes the head to move 10 mm from its furthest forward position may be marked 90° around the aperture from the location where the helix aligns with the aperture when the head is as far forward as possible (a 0 mm displacement). As noted above, the universal clips described herein can be adapted to fit many different pipe sizes. Therefore, some examples have a series of angularly spaced markings around the edge of the aperture, wherein each of the angularly spaced markings corresponds to a different pipe diameter. This provides a quick and easy way for a user to check that the clip has correctly attached to a pipe of a given size. In cases where the pitch is fixed (invariant with longitudinal or angular distance) the markings for different pipe sizes may progress around the aperture. In some cases, additional bands may be provided as noted above to distinguish between optimal attachment and acceptable attachment, or to account for variances in measurement accuracy e.g. due to the pipe having been painted.

In some examples, the helix has a varying pitch such that a single longitudinal line on the surface of the cable intersects the helix at a series of positions corresponding to attachment of the clip to a pipe having a standard pipe diameter. By varying the pitch, a single line of angular location along the cable (e.g. all parts of the cable having 0° as their angular value) can correspond to a different member of a series of commonly used pipe outer diameters. Since clips usually have to be mounted with a particular orientation relative to a pipe, it is often the case that a particular part of the clip will be visible to a user once the clip has been installed. By ensuring that common pipe diameters align with the same angular line along the cable, it can be ensured that the user will be able to see the alignment of the markings. This also means that only a single marking is needed around the aperture (in the above example, this would be a single marking at 0°).

It is simple to determine the helix function H=f(L,θ) which achieves this. First, take the set of commonly used pipes in the context, in keeping with the above example, consider the set of diameters 11 mm, 15 mm, 22 mm or 33 mm. Assuming that the head moves the full diameter to accommodate a pipe, then these correspond to the cable moving 11 mm, 15 mm, 22 mm or 33 mm from its furthest forward position. This means that the helix should have a pitch of 11 mm for the first rotation around the cable, a pitch of (15−11)=4 mm for the second rotation around the cable, a pitch of (22−15)=7 mm for the third rotation around the cable and a pitch of (33−22)=10 mm for the fourth rotation around the cable. In this case to assist a user, the helix may additionally have markings (e.g. along the 0° line) to notify the user which pipe diameter that rotation corresponds to. In some cases, the line along which the helix should align with the mark on the casing (at particular head displacements) may be marked on the cable. In others, the helix is arranged such that such a line could be drawn, but it is not expressly marked on the cable.

Note that while diameters of pipes have been discussed primarily as corresponding to the distance which the head moves, in some cases, depending on the design of the clip, the head may move a distance corresponding to a radius of the pipe. Similarly, some clips do not correspond exactly to either the diameter or the radius, e.g. because the clip itself deforms to fit the pipe, so requiring the head to move a distance which is related to the change in pipe size, but also to the degree of deformation.

The body may include an optical element adjacent to the aperture, for viewing the section of cable adjacent to or within the aperture. As noted, the user may be trying to install the clip in cramped conditions or at awkward angles. It may help to provide an optical element to assist a user in seeing what the cable looks like at or near to the aperture, so that the markings on the cable are clearly visible. The optical element may work by reflection or refraction. For example an annular reflective surface or an annular lens for refracting light reflected from the surface of the cable to better direct reflected light towards a user, thereby allowing a user to better interpret the markings. The optical element may itself have markings on it. For example, in the case of the helical markings, where a mark is placed around the aperture to indicate alignment, the mark may be formed on the optical element, for example in the manner of a crosshair or other suitable shape to better show a user alignment or misalignment between the helix and the mark.

Indeed, the disclosure extends to a cable having the marking systems set out above, that is a marking system for a cable for indicating to a user whether a sensing device is correctly attached to a pipe. The device may be configured to operate by a slidable head which moves to grip a pipe. In this case, the distance which the cable moves relative to the head is an indication of whether the head has moved far enough to contact the pipe. Markers such as one or more bands, colour gradients, helixes and so on, arranged a predetermined distance from the end of the cable (as set out above) can all be indicators of the distance which the head has moved, an consequently of whether the sensing device is correctly installed. Consequently a cable marked for this specific application is itself an independent part of this disclosure.

Means of providing such markings also form part of the disclosure. For example, stencils, decals, printing instructions, etc. for producing the markings described above are also disclosed herein.

Specific examples of the general concepts set out above will now be described with reference to the Figures, in which:

FIG. 1 shows a prior art clip for a pipe or conduit;

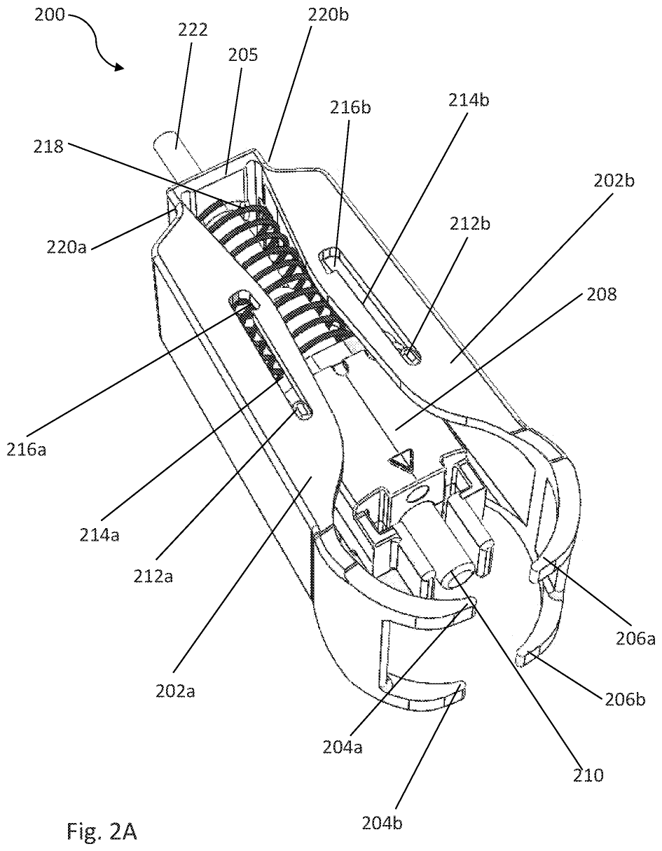

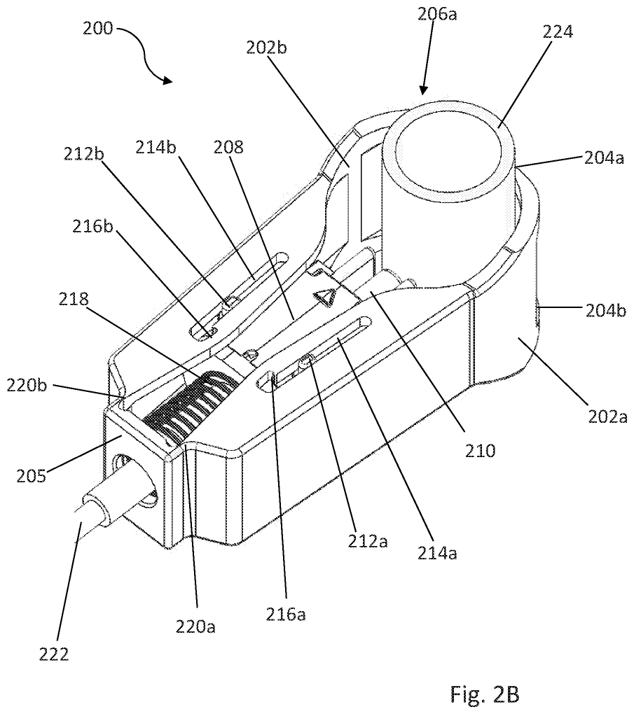

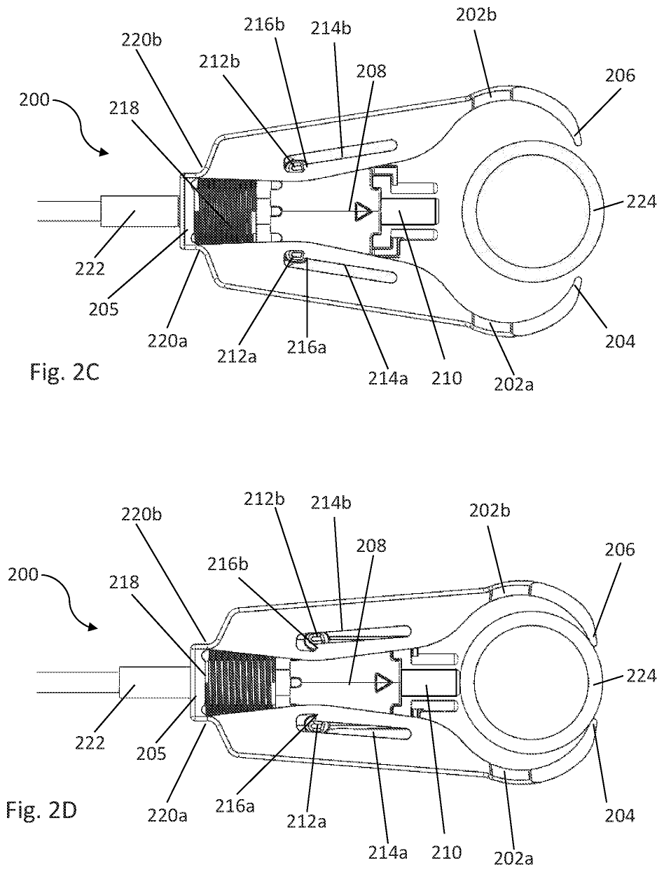

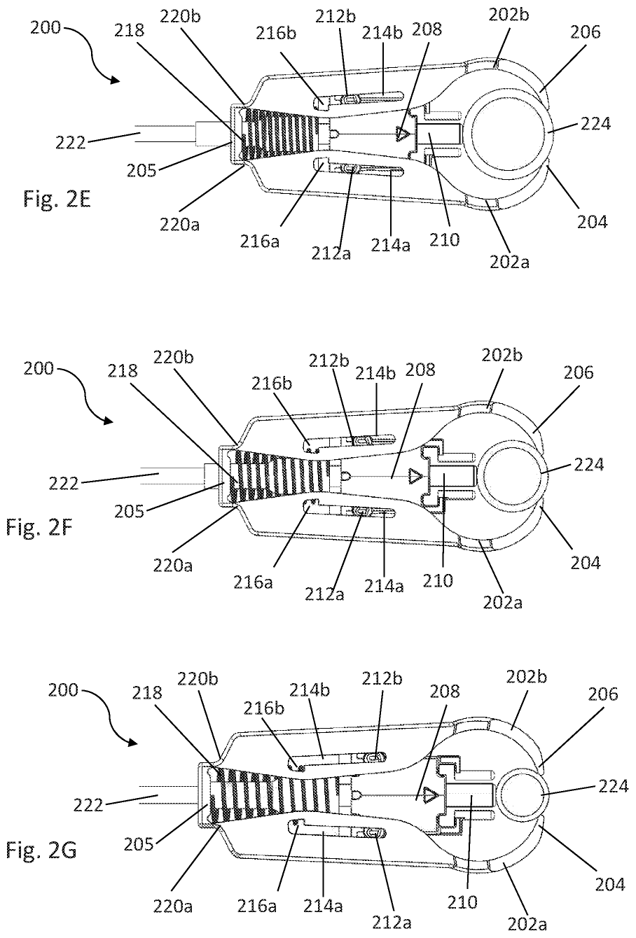

FIG. 2A shows a perspective view of an example of a gripping device;

FIG. 2B shows a perspective view of the device of FIG. 2A from another angle, with a conduit being gripped;

FIG. 2C shows a top view of the device of FIGS. 2A and 2B being fit over a conduit;

FIG. 2D shows a top view of the device of FIGS. 2A to 2C being clipped to a very large conduit;

FIG. 2E shows a top view of the device of FIGS. 2A to 2D being clipped to a large conduit;

FIG. 2F shows a top view of the device of FIGS. 2A to 2E being clipped to a small conduit;

FIG. 2G shows a top view of the device of FIGS. 2A to 2F being clipped to a very small conduit;

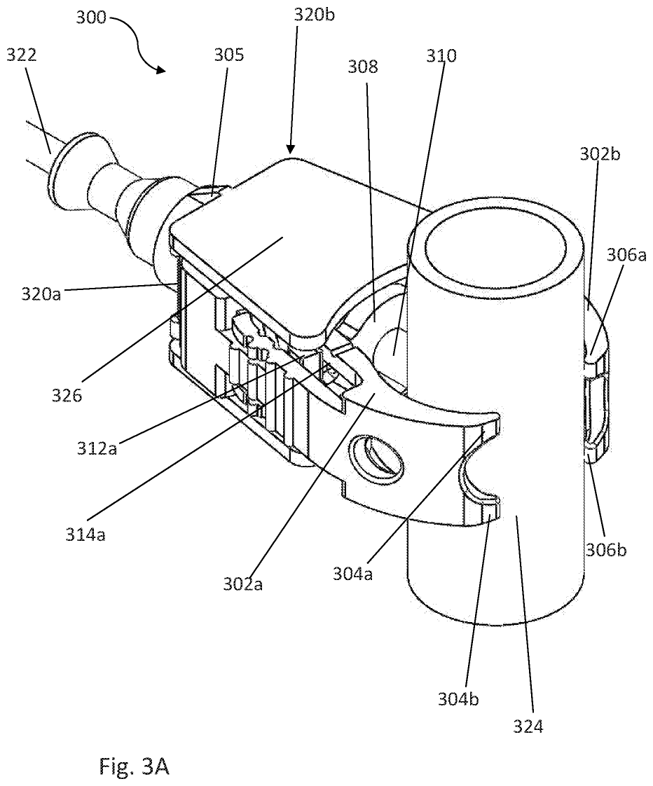

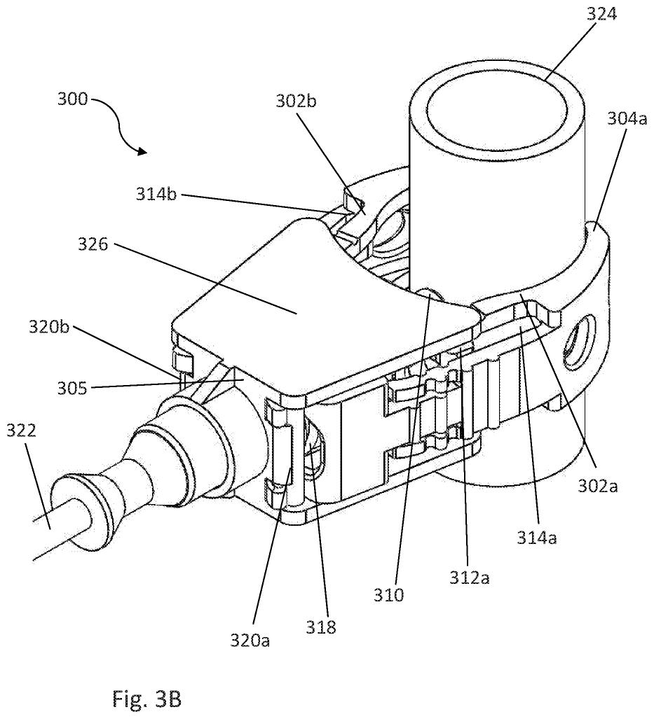

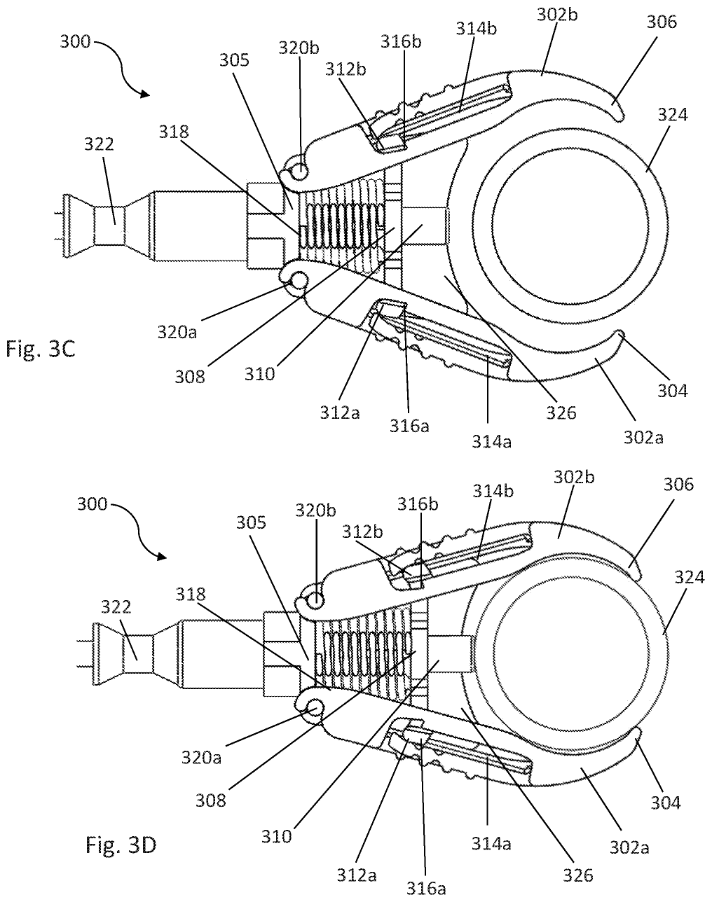

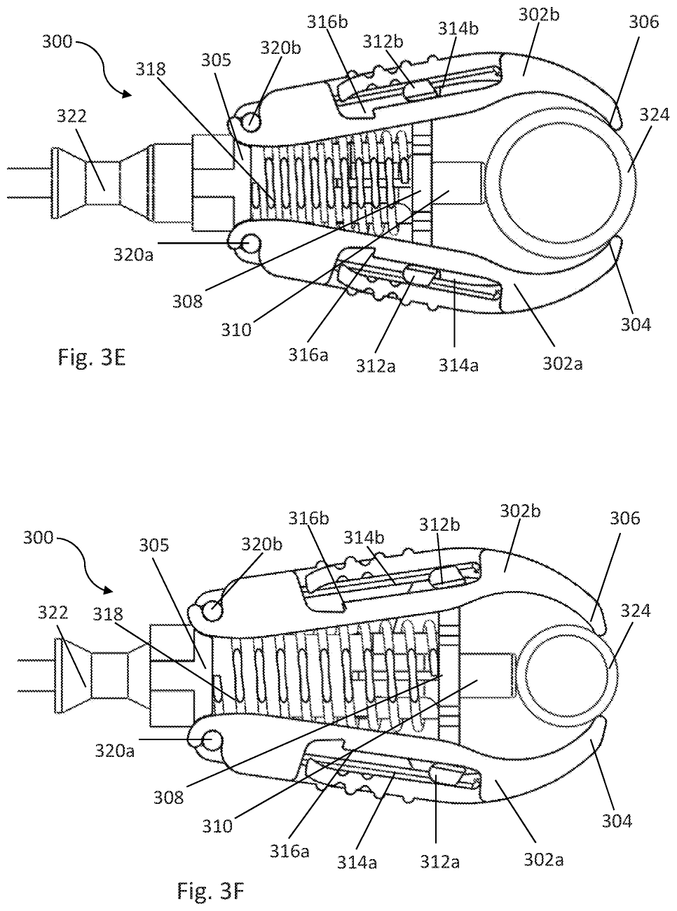

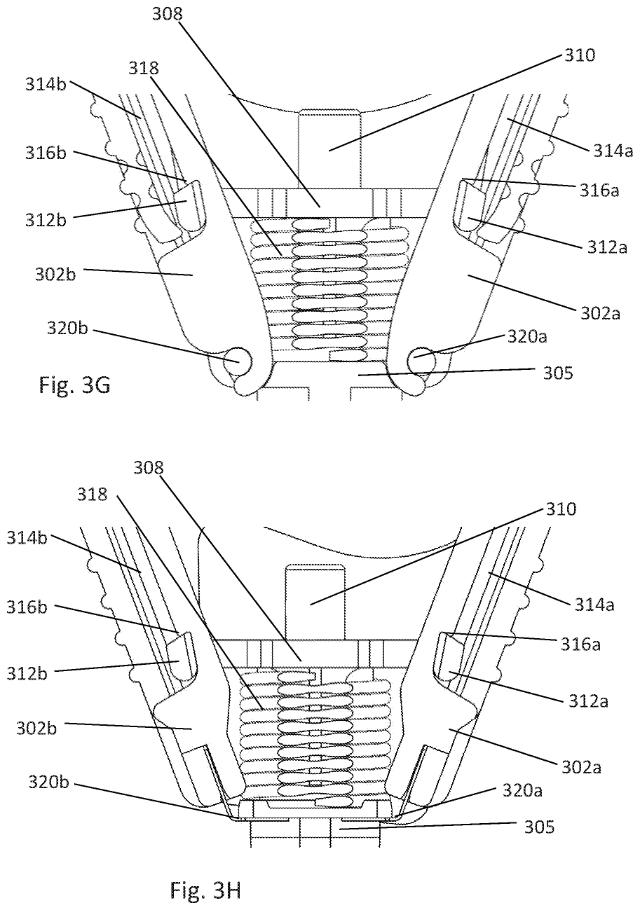

FIG. 3A shows a perspective view of an another design of a gripping device;

FIG. 3B shows a perspective view of the device of FIG. 3A from another angle, with a conduit being gripped;

FIG. 3C shows a top view of the device of FIGS. 3A and 3B being fit over a conduit;

FIG. 3D shows a top view of the device of FIGS. 3A to 3C being clipped to a large conduit;

FIG. 3E shows a top view of the device of FIGS. 3A to 3D being clipped to a medium conduit;

FIG. 3F shows a top view of the device of FIGS. 3A to 3E being clipped to a small conduit;

FIG. 3G shows a detailed top view of the device of FIGS. 3A to 3F, showing an example with hinged jaws;

FIG. 3H shows a detailed top view of the device of FIGS. 3A to 3F, showing an example with sprung jaws;

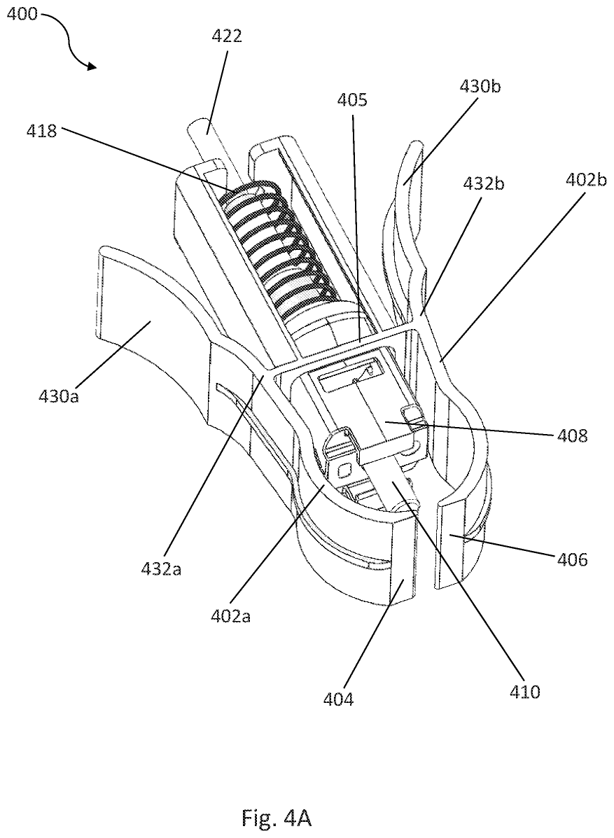

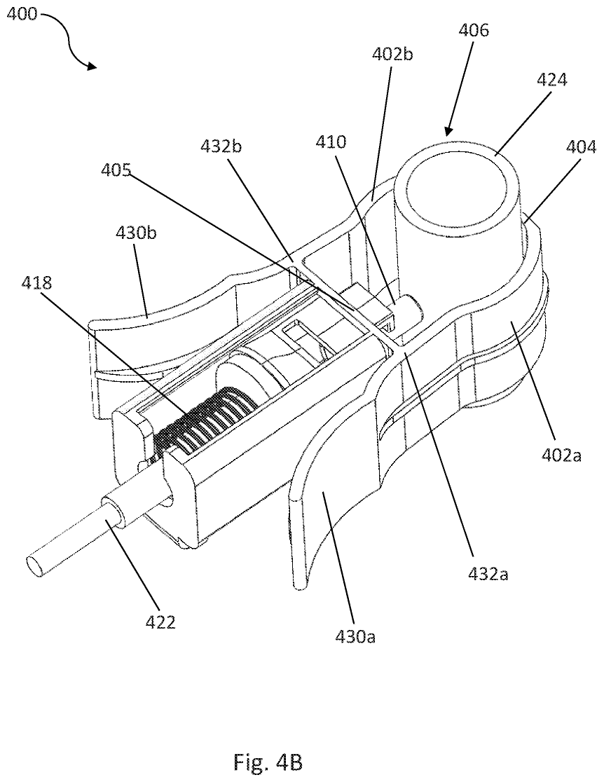

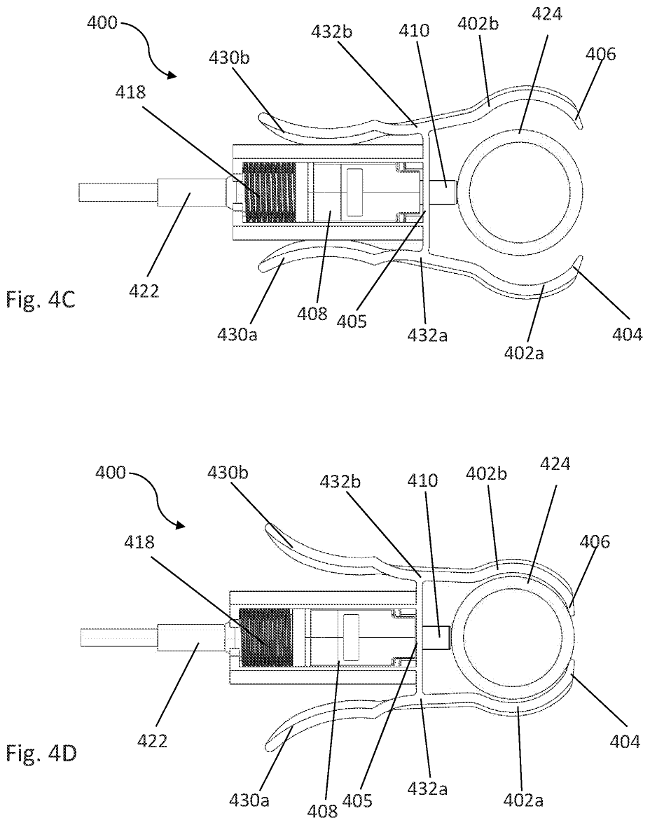

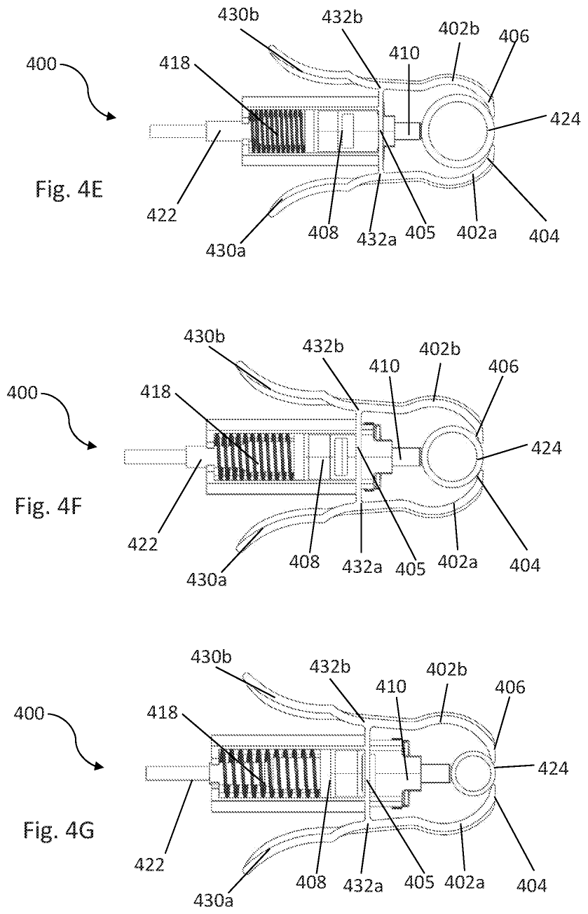

FIG. 4A shows a perspective view of a further example of a gripping device;

FIG. 4B shows a perspective view of the device of FIG. 4A from another angle, with a conduit being gripped;

FIG. 4C shows a top view of the device of FIGS. 4A and 4B being fit over a conduit;

FIG. 4D shows a top view of the device of FIGS. 4A to 4C being clipped to a very large conduit;

FIG. 4E shows a top view of the device of FIGS. 4A to 4D being clipped to a large conduit;

FIG. 4F shows a top view of the device of FIGS. 4A to 4E being clipped to a small conduit;

FIG. 4G shows a top view of the device of FIGS. 4A to 4F being clipped to a very small conduit;

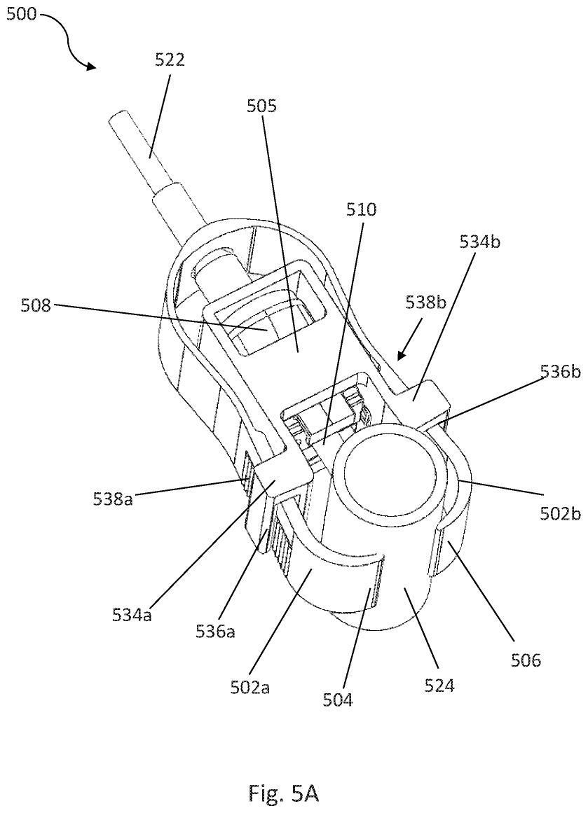

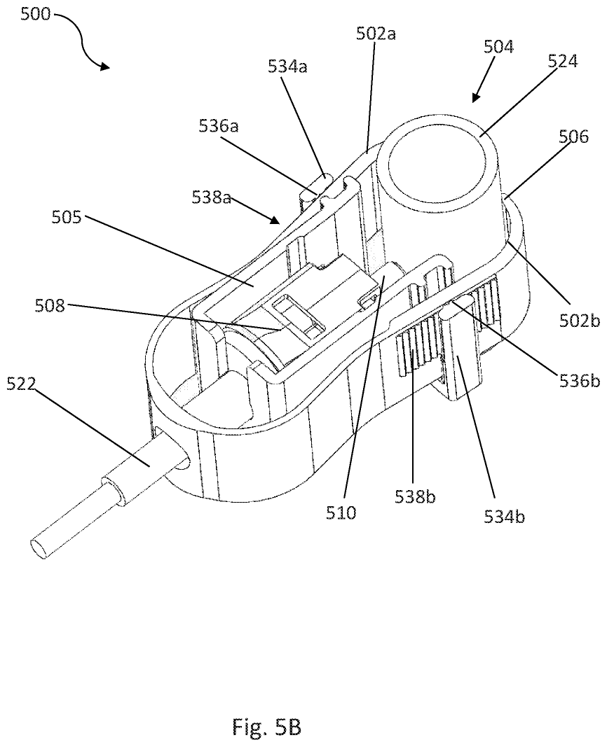

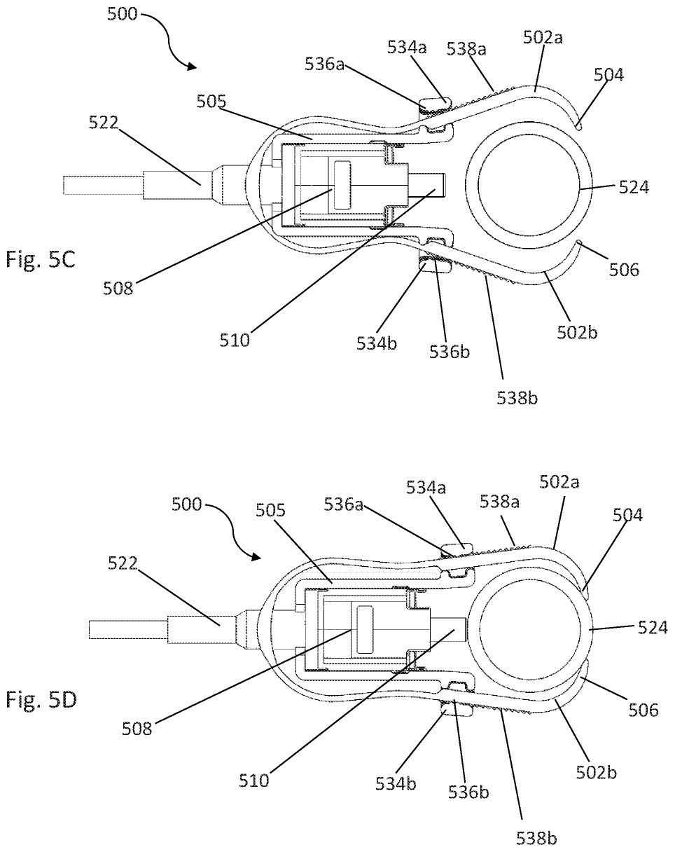

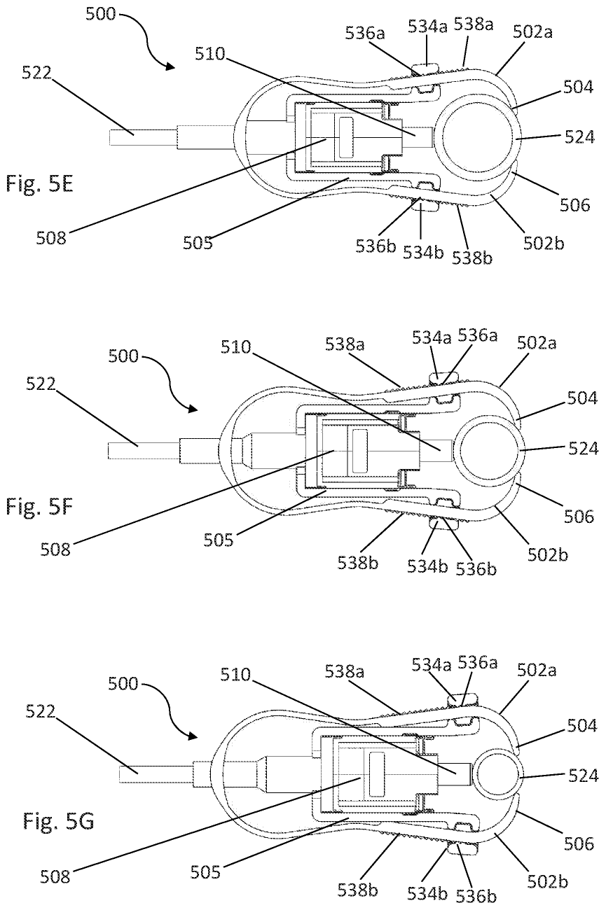

FIG. 5A shows a perspective view of yet another example of a gripping device gripping a conduit;

FIG. 5B shows a perspective view of the device of FIG. 5A from another angle, with a conduit being gripped;

FIG. 5C shows a top view of the device of FIGS. 5A and 5B being fit over a conduit;

FIG. 5D shows a top view of the device of FIGS. 5A to 5C being clipped to a very large conduit;

FIG. 5E shows a top view of the device of FIGS. 5A to 5D being clipped to a large conduit;

FIG. 5F shows a top view of the device of FIGS. 5A to 5E being clipped to a small conduit;

FIG. 5G shows a top view of the device of FIGS. 5A to 5F being clipped to a very small conduit;

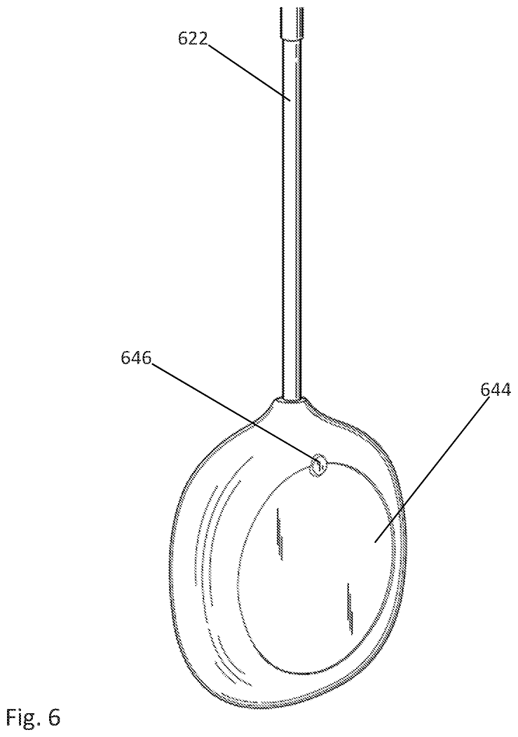

FIG. 6 shows a housing for a processing unit, suitable for connecting to the device of any of FIGS. 2A to 5G;

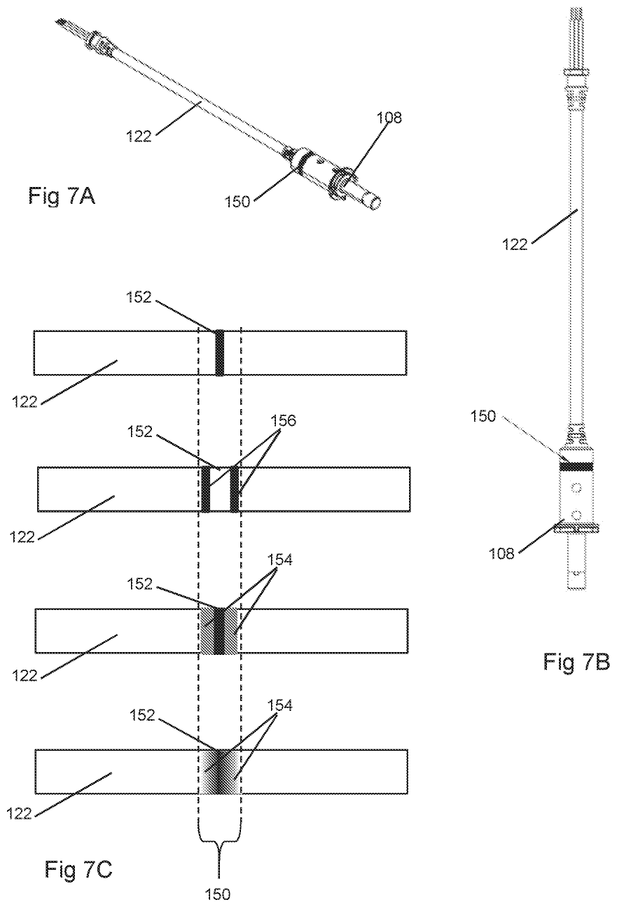

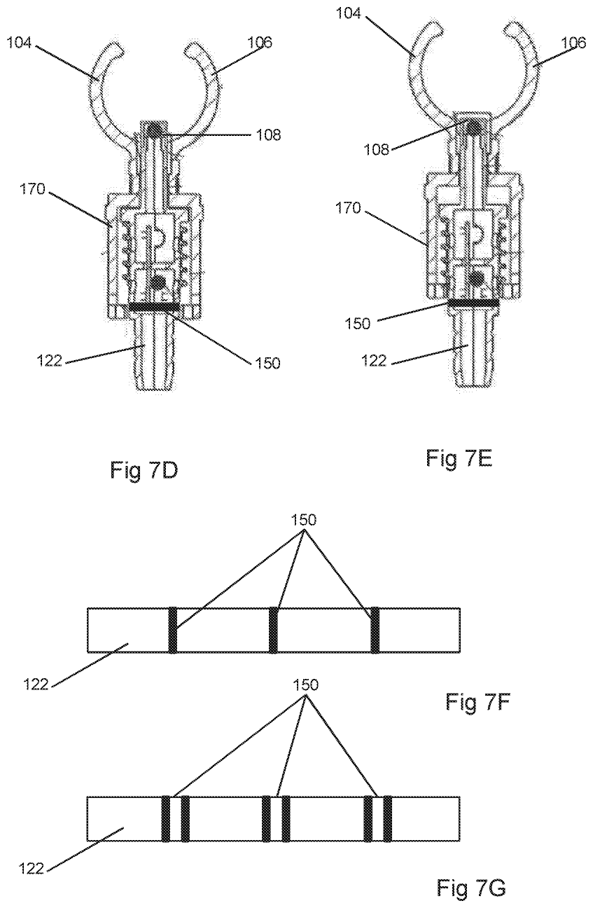

FIGS. 7A and 7B show a cable marked with cable markings for allowing a user to determine whether a clip is correctly attached to a pipe;

FIG. 7C shows a series of variants of the markings shown in FIGS. 7A and 7B;

FIG. 7D shows the cable of FIGS. 7A and 7B in a clip with no retraction of the head;

FIG. 7E shows the cable of FIGS. 7A and 7B in a clip with the head retracted;

FIG. 7F shows a variant of the markings with different markings for different sized pipes;

FIG. 7F shows another variant of the markings with different markings for different sized pipes;

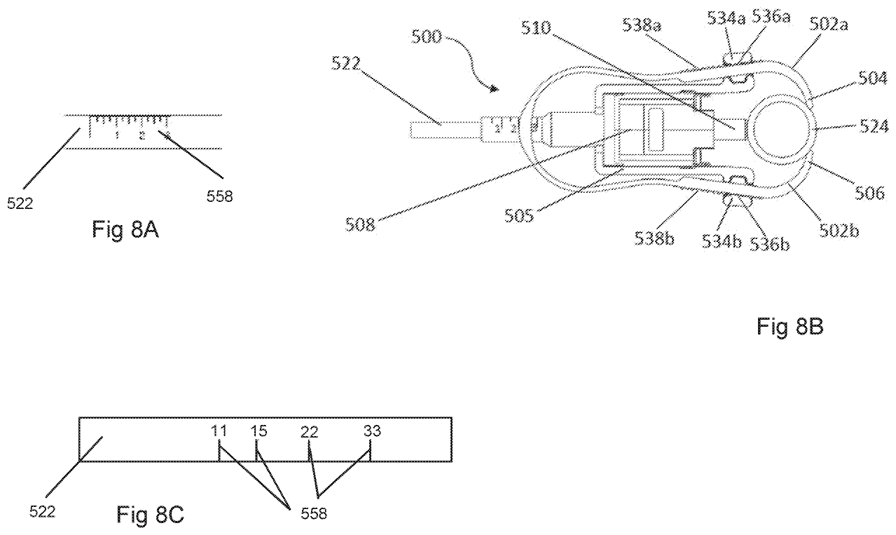

FIG. 8A shows a further variant of the markings for providing a numerical readout;

FIG. 8B shows the variant of FIG. 8A mounted in the device of FIGS. 5A to 5G;

FIG. 8C shows a further variant of the markings for providing a numerical readout;

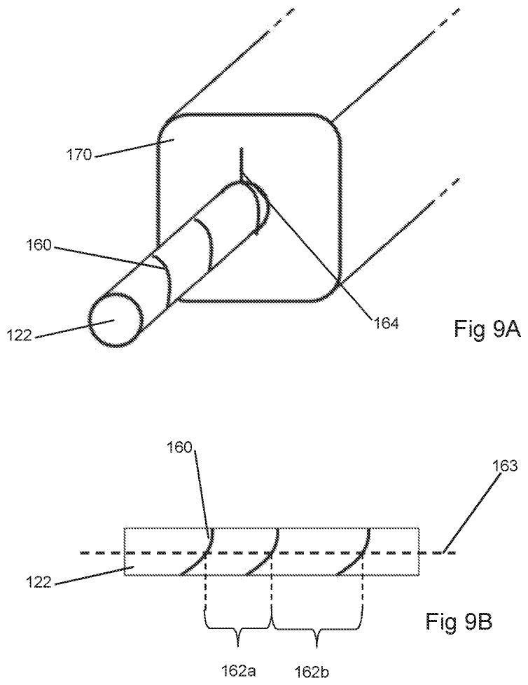

FIGS. 9A and 9B show a variant of the markings having a helical form with a variable pitch;

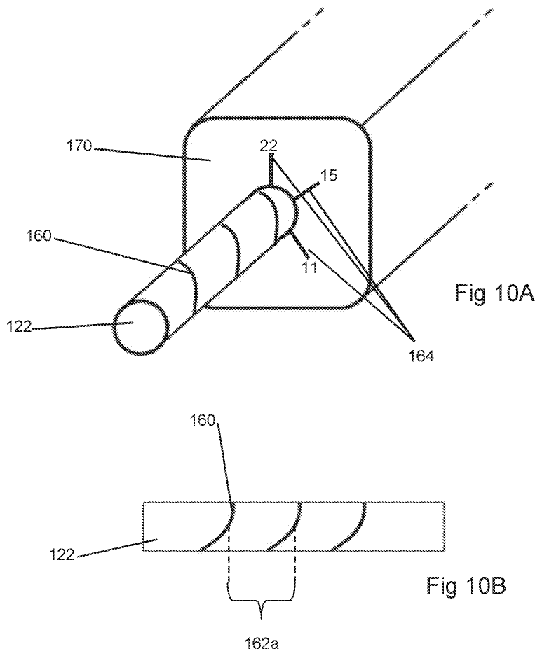

FIGS. 10A and 10B show a variant of the markings having a helical form with a constant pitch; and

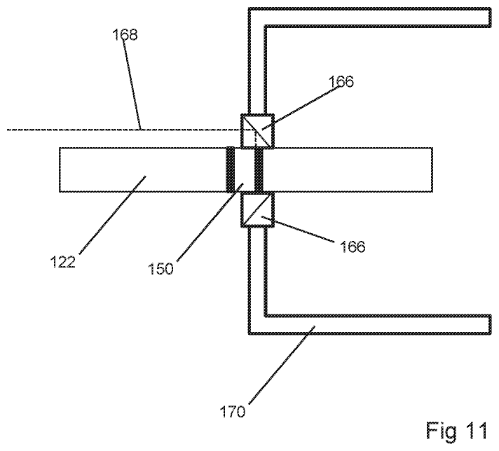

FIG. 11 shows a cross-sectional view of a cable having markings in a device fitted with an optical element to assist a user in viewing the cable in or adjacent to the aperture.

Consider now FIG. 2A in detail. Here a first example of a device 200 is shown in perspective view. A first jaw 202a extends from a first conduit engaging portion 204 to a first pivoting point 220a. Similarly, a second jaw 202b extends from a second conduit engaging portion 206 to a second pivoting point 220b. The jaws 202 are arranged such that the first and second conduit engaging portions 204, 206 are opposed to one another and the first and second pivoting points 220a,b are also opposed to one another. In the example shown in FIG. 2A, each jaw 202 is pivoted via its respective pivoting point 220 to opposing sides of a body 205. Each pivoting point comprises a thinned portion of the material from which the jaws 202 and body 205. The reduced thickness in this portion means that forces on the jaws 202 cause the thinned pivoting portions 220 to flex and act like a pivot (i.e. like a preferential point around which a rotation can occur). Pivoting of one or both of the jaws 202 around its/their pivot point(s) causes the conduit engaging portions 204, 206 to come closer together or moves them further apart. In some cases, the pivoting points 220 may comprise a joint in which the jaws 202 and the body 205 are separate entities and are coupled together by a hinge or similar pivoting connection (see e.g. FIGS. 3A to 3G).

In the example shown, each conduit engaging portion 204, 206 comprises a forked portion for gripping a conduit. That is to say, the first conduit engaging portion 204 splits into upper and lower portions 204a, 204b and the second conduit engaging portion 206 splits into upper and lower portions 206a, 206b so that the actual area of the grip is reduced overall. In some examples, there is no such split.

Between the jaws 202 a head 208 is mounted. Extending from a forward end of the head 208, substantially aligned with the jaws 202, is a third conduit engaging portion 210. The opposite, rear, end of the head engages with a biasing means 218, in this case a spring. The other end of the spring 218 abuts the body 205. The effect of this arrangement is that the head 208 is biased by the spring 218 away from the body 205 and towards the conduit engaging portions 204, 206 of the jaws 202. Since the third conduit engaging portion 210 is attached to the head 208, the third engaging portion 210 also moves towards the first and second conduit engaging portions 204, 206. A conduit may therefore be gripped by the three conduit engaging portions 204, 206 210 coming together in this manner. Also extending from the rear end of the head 208 is a cable 222, for connecting the device to e.g. a processor or communications unit for processing or communicating measured data.

The head 208 has four projections 212, two (212a,b) on its upper surface and two on its lower surface (not visible in the Figure). Each projection 212 is retained in a groove 214 on a respective jaw 202, where the groove 214 is a slit extending through the entire body of the jaw 202. Specifically, a first projection 212a is retained in a first groove 214a which is located on the first jaw 202a and a second projection 212b is retained in a second groove 214b which is located on the second jaw 202b. Each of the jaws 202 has a corresponding groove 214 (third and fourth grooves) opposite the grooves 214 which are visible in the Figure, for retaining a corresponding protrusion 212. The interaction between the protrusions 212 and the grooves 214 helps to guide the head 208 and retain the head 208 stably between the jaws.

In addition, the shape of the groove 214 can be used to determine the dynamics of the interaction between the head 208 and the jaws 202. For example, since the protrusions 212 are spaced a fixed distance apart on the head 208, the point at which the protrusions 212 contact the groove 214 is also forced to be this fixed distance apart. When the arrangement of the pivot points 220 and the jaws 202 is such that the grooves 214 taper for all or part of their length (e.g. straight tapered or curved), then moving the head 208 relative to the jaws 202 will change the portion of the jaw 202 which is forced to be separated by the distance between the protrusions 212. Since this distance is fixed, the system responds by moving the jaws 202 towards each other or further apart, depending on where the protrusions 212 contact the grooves 214. Note that this effect could also be achieved by positioning the grooves 214 on the head 208 and the protrusions 212 on the jaws 202. Moreover, while four grooves 214 with corresponding protrusions 212 are presented in this example, there could be fewer sets than this. For example, these could be limited to a single jaw 202, or limited to only the upper (or lower) surface of the jaws 202.

When this interaction is coupled with the biasing means 218, the head 208 is forced towards the first and second conduit engagement portions 204, 206. This causes the jaws 202 to move closer together, and consequently the device overall is biased towards a configuration in which the jaws 202 are closer together than other configurations. For example, if the head 208 is pulled backwards, then the jaws 202 will be spread further apart, but in general this configuration is not stable due to the biasing means 218, and the device 200 will revert to the configuration where the jaws 202 are closer together. The head 208 is prevented from travelling beyond a certain point by the protrusions 212 reaching the end of their respective grooves 214. This also limits how close together the jaws 202 are able to be in the example shown.

For ease of use, the device 200 can be held in a second configuration in which the jaws 202 are spaced further apart than they are in the first configuration. This functionality is provided by a first notch 216a in the first groove 214a and a second notch 216b in the second groove 214b. Each notch 216 is located towards the same end of the jaws 202 as the body 205. Corresponding notches are located in the non-visible grooves 214 on the underside of the device 200. The notches 216 provide a location in which the protrusions 212 can sit. The notches 216 are shaped so that when a protrusion 212 rests in its corresponding notch 216, the protrusion abuts the edge of the notch 216, which provides resistance to the force of the biasing means. This resistance prevents the head 208 from sliding relative to the jaws 202, and consequently holds the device 200 in the second configuration (in which the jaws are spaced apart). A small pressure on the jaws 202 to bring them closer together is enough to move protrusions 212 from their position of relative stability in their notches 216. Once this happens, the protrusion once more becomes aligned with the groove 214. Since the biasing means 218 exerts a force on the head 208, the protrusions 212 are forced along the grooves 214 until the device 200 once more settles in the first configuration.

In use, a user draws the head 208 backwards (away from the conduit engaging portions 204, 206) until the protrusions are located in notches 216 and the device 200 stably retains this configuration, as described above. The device 200 may then be fit over a conduit and a small inward pressure applied to the jaws 202. This releases the protrusions 212 from the notches 216 and allows the head 208 to move back towards the conduit engaging portions 204, 206. Since the conduit is between the jaws 202, the third conduit engaging portion 210 will abut against the conduit and thereby stop the movement of the head 208 by resisting the force exerted by the biasing means 218 (e.g. spring). At the same time, as described above, the jaws 202 are drawn together by virtue of the interaction between the protrusions 212 and the grooves 214, as described above.

FIG. 2B shows the device 200 of FIG. 2A clipped onto a conduit 224. Here it can be seen that the head 208 is retained some way between the stable, second configuration in which the protrusions 212 are located in the notches 216 and the first configuration in which the first, second and third conduit engaging portions 204, 206, 210 are as close together as possible. A conduit 224 is gripped between the first, second and third conduit engaging portions 204, 206, 210 and the third conduit engaging portion 210 is pressed against the conduit 224. Since the first and second conduit engaging portions 204, 206 fit behind the conduit, the force exerted by the biasing means 218 is resisted, thereby preventing the third conduit engaging portion 210 from moving further forwards. In some examples the third conduit engaging portion 210 comprises a sensor, which is pressed securely against the surface of the conduit 224. This arrangement provides good contact, which is beneficial for particular types of sensor, e.g. thermometers. In some cases, the sensor may not actually be exposed to the surface of the conduit 224 but is shielded by a suitable cover. For example, a temperature sensor can be mounted behind a high thermal conductivity shield, which is nevertheless rugged enough to protect the sensor. Metallic covers are appropriate for this role.

FIGS. 2C to 2G show the device 200 of FIGS. 2A and 2B in the process of gripping conduits 224 of various sizes. In FIG. 2C, the device 200 is in the second configuration in which the jaws 202 have been held at a wide spacing by the protrusions 212 engaging with the notches 216. This results in the jaws 202 being spaced widely enough to fit around a very large conduit 224. In this context, a “very large” conduit 224 is one that is approximately as large as the largest one which the device 200 is intended to accommodate. It can be seen that a small amount of additional flexing of the jaws 202 may have been necessary to fit such a large conduit 224 between the jaws 202. Nonetheless, the degree of flexing (and therefore the force) required to accommodate this size of conduit 224 is significantly less than would be required with the design shown in FIG. 1.

With the conduit 224 located between the jaws 202, a small inward force on the jaws 202 is enough to disengage the protrusions 212 from the notches 216. Therefore, a gentle squeeze from a user causes the protrusions 212 to be freed from the notches 216, allowing the head 208 to slide until the third conduit engaging portion 210 contacts the conduit. In FIG. 2D, it can be seen that the head 208 does not slide very far before this happens. As a result, the spring 218 remains largely compressed and the protrusions remain close to (but are disengaged from) the notches 216. While the protrusions 212 are located far from the location at the end of the groove 214 which they occupy when the device 200 is in the first configuration, the arrangement in FIG. 2D is nevertheless a stable one because the conduit 224 prevents the head 208 from sliding any further towards the conduit gripping portions 204, 206, while the biasing means 218 prevents the head 208 from sliding away from the conduit gripping portions 204, 206.

The device 200 of FIGS. 2A to 2D is shown gripping a large, small and very small conduit 224 in FIGS. 2E to 2G respectively. In this context, “large” means a conduit 224 which is towards the larger end of the range of conduits for which the device 200 is designed, but is by no means the largest. Likewise, “small” means a conduit 224 which is towards the smaller end of the range of conduits for which the device 200 is designed, but is by no means the smallest. “Very small” refers to a conduit 224 that is approximately as small as the smallest one which the device 200 is intended to accommodate.

Note that as the device 200 is used to grip yet smaller conduits 224, the head 208 moves further forwards (towards the conduit gripping portions 204, 206) under the action of the biasing means 218. This action also causes the jaws 202 to be brought together to contact the smaller conduit 224 size, by virtue of the interaction between the protrusions 212 and the grooves 214. The jaws 202 are curved such that they only contact the conduit 224 over a small area, since the curvature of the jaws 202 does not match the curvature of the conduit 224 at the point of contact. In every case, there are three points of contact between the device 200 and the conduit 224, thereby providing a secure grip. In order to release the device 200 from the conduit, the third conduit engaging portion 210 can be pushed harder against the conduit 224 to force the head 208 backwards against the force provided by the biasing means 218 until the protrusions 212 can be located in the notches 216. Once the device 200 is in the second configuration, the jaws 202 will be wide enough to fit over the conduit 224, and the device 200 can be easily removed from the conduit 224.

In FIG. 3A is shown a similar design 300 to that shown in FIG. 2, in perspective view. A first jaw 302a extends from a first conduit engaging portion 304 to a first pivoting point 320a. Similarly, a second jaw 302b extends from a second conduit engaging portion 306 to a second pivoting point 320b. The jaws 302 are arranged such that the first and second conduit engaging portions 304, 306 are opposed to one another and the first and second pivoting points 320a,b are also opposed to one another. In the example shown, a conduit 324 is gripped between the jaws 302. In the example shown in FIG. 3A, each jaw 302 is pivoted via its respective pivoting point 320 to opposing sides of a body 305. Each pivoting point comprises a hinged portion which will be described in more detail later.

In the example shown, each conduit engaging portion 304, 306 comprises a forked portion for gripping a conduit. That is to say, the first conduit engaging portion 304 splits into upper and lower portions 304a, 304b and the second conduit engaging portion 306 splits into upper and lower portions 306a, 306b so that the actual area of the grip is reduced overall. In some examples, there is no such split. Depending on design considerations, the increased contact area of a non-forked design can provide some additional gripping strength, if required. Conversely, providing a forked design can reduce the thermal contact, albeit at the cost of reduced gripping strength.

Between the jaws 302 a head 308 is mounted. Extending from a forward end of the head 308, substantially aligned with the jaws 302, is a third conduit engaging portion 310. The opposite, rear, end of the head engages with a biasing means (not visible here). The head 308 and the biasing means are protected by a cover 326, which prevents damage to or dirt getting into the device. The other end of the biasing means abuts the body 305. The effect of this arrangement is that the head 308 is biased by the biasing means away from the body 305 and towards the conduit engaging portions 304, 306 of the jaws 302. Since the third conduit engaging portion 310 is attached to the head 308, the third engaging portion 310 also moves towards the first and second conduit engaging portions 304, 306. A conduit may therefore be gripped by the three conduit engaging portions 304, 306 310 coming together in this manner. Also extending from the rear end of the head 308 is a cable 322, for connecting the device to e.g. a processor or communications unit for processing or communicating measured data.

The head 308 has four projections 312, two (312a,b) on its upper surface and two on its lower surface (not visible in the Figure). Each projection 312 is retained in a groove 314 on a respective jaw 302, where the groove 314 is a slit extending through the entire body of the jaw 302. Specifically, a first projection 312a is retained in a first groove 314a which is located on the first jaw 302a and a second projection 312b is retained in a second groove 314b which is located on the second jaw 302b. Each of the jaws 302 has a corresponding groove 314 (third and fourth grooves) opposite the grooves 314 which are visible in the Figure, for retaining a corresponding protrusion 312. The interaction between the protrusions 312 and the grooves 314 helps to guide the head 308 and retain the head 308 stably between the jaws. In other words, the motion of the head 308 and the jaws 302 is coupled by virtue of the interaction between the grooves 314 and the protrusions 316.

In addition, the shape of the groove 314 can be used to determine the dynamics of the interaction between the head 308 and the jaws 302. For example, since the protrusions 312 are spaced a fixed distance apart on the head 308, the point at which the protrusions 312 contact the groove 314 is also forced to be this fixed distance apart. When the arrangement of the pivot points 320 and the jaws 302 is such that the grooves 314 taper for all or part of their length (e.g. straight tapered or curved), then moving the head 308 relative to the jaws 302 will change the portion of the jaw 302 which is forced to be separated by the distance between the protrusions 312. Since this distance is fixed, the system responds by moving the jaws 302 towards each other or further apart, depending on where the protrusions 312 contact the grooves 314. Note that this effect could also be achieved by positioning the grooves 314 on the head 308 and the protrusions 312 on the jaws 302. Moreover, while four grooves 314 with corresponding protrusions 312 are presented in this example, there could be fewer sets than this. For example, these could be limited to a single jaw 302, or limited to only the upper (or lower) surface of the jaws 302.

When this interaction is coupled with the biasing means 318, the head 308 is forced towards the first and second conduit engagement portions 304, 306. This causes the jaws 302 to move closer together, and consequently the device overall is biased towards a configuration in which the jaws 302 are closer together than other configurations. For example, if the head 308 is pulled backwards, then the jaws 302 will be spread further apart, but in general this configuration is not stable due to the biasing means, and the device 300 will revert to the configuration where the jaws 302 are closer together. The head 308 is prevented from travelling beyond a certain point by the protrusions 312 reaching the end of their respective grooves 314. This also limits how close together the jaws 302 are able to be in the example shown.

FIG. 3B shows the device 300 of FIG. 3A clipped onto a conduit 324. Here it can be seen that the head 308 is retained some way between the stable, second configuration and the first configuration in which the first, second and third conduit engaging portions 304, 306, 310 are as close together as possible. A conduit 324 is once more gripped between the first, second and third conduit engaging portions 304, 306, 310 and the third conduit engaging portion 310 is pressed against the conduit 324. Since the first and second conduit engaging portions 304, 306 fit behind the conduit, the force exerted by the biasing means 318 (in this case a spring) is resisted, thereby preventing the third conduit engaging portion 310 from moving further forwards. In some examples the third conduit engaging portion 310 comprises a sensor, which is pressed securely against the surface of the conduit 324. This arrangement provides good contact, which is beneficial for particular types of sensor, e.g. thermometers. In some cases, the sensor may not actually be exposed to the surface of the conduit 324 but is shielded by a suitable cover. For example, a temperature sensor can be mounted behind a high thermal conductivity shield, which is nevertheless rugged enough to protect the sensor. Metallic covers are appropriate for this role.

The pivoting points 320 are shown in detail here, and take the form of a hinge. A clip on the jaws 302 fits over a rod on the body 305, in such a way that the jaws 302 can rotate (i.e. pivot) and change the separation of the conduit engaging portions 304, 306. The cover 326 is attached to the body 305 and provides a convenient platform from which the rods forming part of the pivoting points 320 extend. In the present example, there are upper and lower plates 326 and the rods extend between these.

FIGS. 3C to 3G show more of the protrusion 312 and groove 314 system of this example, which is normally protected by the cover 326. For ease of use, the device 300 can be held in a second configuration in which the jaws 302 are spaced further apart than they are in the first configuration. This functionality is provided by a first notch 316a in the first groove 314a and a second notch 316b in the second groove 314b. Each notch 316 is located towards the same end of the jaws 302 as the body 305. Corresponding notches are located in the non-visible grooves 314 on the underside of the device 300. The notches 316 provide a location in which the protrusions 312 can sit. The notches 316 are shaped so that when a protrusion 312 rests in its corresponding notch 316, the protrusion abuts the edge of the notch 316, which provides resistance to the force of the biasing means (see FIGS. 3C, 3G and 3H). This resistance prevents the head 308 from sliding relative to the jaws 302, and consequently holds the device 300 in the second configuration (in which the jaws are spaced apart). A small pressure on the jaws 302 to bring them closer together is enough to move protrusions 312 from their position of relative stability in their notches 316. Once this happens, the protrusion once more becomes aligned with the groove 314. Since the biasing means 318 exerts a force on the head 308, the protrusions 312 are forced along the grooves 314 until the device 300 once more settles in the first configuration (see e.g. FIG. 3F).

Note that the grooves 314 in this case comprise a continuous wall on the inner side, but an incomplete, inwardly curving wall on the outer side. The curved part of the wall helps to guide the protrusions 312 into the notches 316 when the head is drawn backwards by pressing inwardly relative to the jaws. The wall being incomplete allows the outer wall to flex, which can help to ensure that the protrusion 312 is able to escape the notch 316 when the user wishes it to. When the user exerts an inward force on the jaws 302, the protrusions 312 are pressed against the outer wall of the groove 314, which is in turn pushed out of the way by virtue of its not being connected to the jaw/body. The unconnected wall is resiliently deformable, in that it when it is pushed out of the way in this manner, it springs back to the configuration shown once the protrusion 312 is no longer forcing it to adopt a different configuration.

In use, a user draws the head 308 backwards (away from the conduit engaging portions 304, 306) until the protrusions are located in notches 316 and the device 300 stably retains this configuration, as described above. The device 300 may then be fit over a conduit and a small inward pressure applied to the jaws 302. This releases the protrusions 312 from the notches 316 and allows the head 308 to move back towards the conduit engaging portions 304, 306. Since the conduit is between the jaws 302, the third conduit engaging portion 310 will abut against the conduit and thereby stop the movement of the head 308 by resisting the force exerted by the biasing means 318 (e.g. spring). At the same time, as described above, the jaws 302 are drawn together by virtue of the interaction between the protrusions 312 and the grooves 314, as described above.

FIGS. 3C to 3F show the device 300 of FIGS. 3A and 3B in the process of gripping conduits 324 of various sizes. In FIG. 3C, the device 300 is in the second configuration in which the jaws 302 have been held at a wide spacing by the protrusions 312 engaging with the notches 316. This results in the jaws 302 being spaced widely enough to fit around a large conduit 324. In this context, a “large” conduit 324 is one that is approximately as large as the largest one which the device 300 is intended to accommodate. It can be seen that a small amount of additional flexing of the jaws 302 may have been necessary to fit such a large conduit 324 between the jaws 302. Nonetheless, the degree of flexing (and therefore the force) required to accommodate this size of conduit 324 is significantly less than would be required with the design shown in FIG. 1.

With the conduit 324 located between the jaws 302, a small inward force on the jaws 302 is enough to disengage the protrusions 312 from the notches 316. Therefore, a gentle squeeze from a user causes the protrusions 312 to be freed from the notches 316, allowing the head 308 to slide until the third conduit engaging portion 310 contacts the conduit. In FIG. 3D, it can be seen that the head 308 does not slide very far before this happens. As a result, the spring 318 remains largely compressed and the protrusions remain close to (but are disengaged from) the notches 316. While the protrusions 312 are located far from the location at the end of the groove 314 which they occupy when the device 300 is in the first configuration, the arrangement in FIG. 3D is nevertheless a stable one because the conduit 324 prevents the head 308 from sliding any further towards the conduit gripping portions 304, 306, while the biasing means 318 prevents the head 308 from sliding away from the conduit gripping portions 304, 306.

The device 300 of FIGS. 3A to 3D is shown gripping a medium and a small conduit 324 in FIGS. 2E and 2F respectively. In this context, “medium” means a conduit 324 which is sized between the largest and smallest conduits for which the device 300 is designed. Likewise, “small” refers to a conduit 324 that is approximately as small as the smallest one which the device 300 is intended to accommodate.

Note that as the device 300 is used to grip yet smaller conduits 324, the head 308 moves further forwards (towards the conduit gripping portions 304, 306) under the action of the biasing means 318. This action also causes the jaws 302 to be brought together to contact the smaller conduit 324 size, by virtue of the interaction between the protrusions 312 and the grooves 314. The jaws 302 are curved such that they only contact the conduit 324 over a small area, since the curvature of the jaws 302 does not match the curvature of the conduit 324 at the point of contact. In every case, there are three points of contact between the device 300 and the conduit 324, thereby providing a secure grip. In order to release the device 300 from the conduit, the third conduit engaging portion 310 can be pushed harder against the conduit 324 to force the head 308 backwards against the force provided by the biasing means 318 until the protrusions 312 can be located in the notches 316. Once the device 300 is in the second configuration, the jaws 302 will be wide enough to fit over the conduit 324, and the device 200 can be easily removed from the conduit 324.

In FIGS. 3G and 3H, a close up of the pivoting points 320 is shown. Two main differences between these Figures may be discerned, the first of which is the pivoting points 320 themselves. FIG. 3G shows the hinged pivoting points 320 described above, while FIG. 3H shows pivoting points 320 formed by springy strips with one end attached to a jaw 302 and one to the body 305. The spring strips operate by flexing when a force is applied, but returning to their equilibrium position (the one shown in FIG. 3H) once a force is no longer being applied. This springiness helps to maintain the jaws 302 in an equilibrium position, which can be chosen to provide an increased gripping force (i.e. the equilibrium position corresponds broadly to the first configuration of the jaws 302).

The second difference between FIGS. 3G and 3H relates to the grooves 314. While the grooves in FIG. 3G are those described above, the grooves in FIG. 3H have a continuous and straight outer wall for retaining the protrusion 312. It will be clear to those skilled in the art that these two features highlighted in the differences between FIGS. 3G and 3H are independent of one another, and some examples may have any combination of these two variants.

In FIG. 4A, another example of a device 400 is shown. In this example, a first jaw 402a extends from a first conduit engaging portion 404 to a first pivoting point 432a. A first handle 430a extends backwards beyond the first pivoting point 432a. Similarly, a second jaw 402b extends from a second conduit engaging portion 406 to a second pivoting point 432b and a second handle 430b extends backwards beyond the second pivoting point 432b. The jaws 402 are arranged such that the first and second conduit engaging portions 404, 406 are opposed to one another and the first and second pivoting points 432a,b are also opposed to one another. In the example shown in FIG. 4A, each jaw 402 is pivoted via its respective pivoting point 432 to opposing sides of a body 405. Each pivoting point comprises a T-junction with a handle 430 and jaw 402 forming the cross piece, and the stem being formed by part of the body 405. This arrangement means that when a handle 430 is moved, its respective pivot point 432 flexes and moves the respective jaw 402. The pivoting action means that an inward motion on a handle 430 translates to an outward motion on the corresponding jaw 402.

The motion on the handles 430 in this regard is limited. For example, it is not possible to widen the handles 430 past a certain point because the conduit engaging portions 404, 406 will abut one another at some point in the process, thereby preventing further movement. Similarly, the body 405 extends backwards (i.e. away from the first and second conduit engaging portions 404, 406) so that a portion of it is located between the handles 430. As the handles 430 are moved inwards, they eventually abut this portion of the body 405, which therefore prevents further movement of the handles 430 in this direction. This also prevents further motion of the jaws 402, at least by virtue of the handles 430 being moved (but e.g. directly flexing the jaws is still possible), thereby limiting the maximum jaw separation in this way.

When the handles 430 are not operated by a user, the device 400 adopts an equilibrium position, in which the jaws 402 are located close to one another (and correspondingly the conduit engaging portions 404, 406 are also close together). The jaws 402 are biased in this way so that when a conduit is placed between them, they exert an inward force and grip the conduit. Similarly, a user is able to retain the jaws 402 in a second, open configuration, in which the jaws 402 are spaced wider apart than they are in the equilibrium position, by holding the handles 430 close to the body 405.

A head 408 is mounted between the jaws 402, and is retained in place by a portion of the body 405. The head 408 is slidable within the body 405 and is biased to slide forwards towards the conduit engaging portions 404, 406 by a biasing means 418, in this case a spring, which engages with a rear end of the head 408. The other end of the spring 418 abuts the body 405. Extending from the end of the head 408 closest to the first and second conduit engaging portions 404, 406 (in a forwards direction, opposite to the portion which engages with the biasing means 418), substantially aligned with the jaws 402, is a third conduit engaging portion 410. The effect of this arrangement is that the head 408 is biased by the spring 418 away from the body 405 and towards the conduit engaging portions 404, 406 of the jaws 402. Since the third conduit engaging portion 410 is attached to the head 408, the third engaging portion 410 also moves towards the first and second conduit engaging portions 404, 406. A conduit may therefore be gripped by the three conduit engaging portions 404, 406 410 coming together in this manner. Also extending from the rear end of the head 408 is a cable 422, for connecting the device to e.g. a processor or communications unit for processing or communicating measured data.

The head 408 is mounted within a guide formed in the body 405 which ensures that the head 408 slides in a direction that is broadly towards or away from the gap between the first and second conduit engaging portions 404, 406.

In use, a user actuates the handles 430 by pressing them close to the body 405. This forces the jaws 402 and therefore conduit engaging portions 404, 406 further apart by virtue of the action of the pivoting points 432. In this configuration, the jaws 402 are wide enough to fit around any conduit for which the device 400 has been designed. The device 400 can therefore be fit over the conduit. Once the third conduit engaging portion 410 has contacted the conduit, applying a force to the device 400 forces the head 408 backwards against the action of the biasing means 418. This ensures that the first and second conduit engaging portions 404, 406 can be pushed past the widest portion of the conduit. Once this has happened, the handles 430 can be released, causing the first and second conduit engaging portions 404, 406 to move inwards and grip the conduit.

FIG. 4B shows the device 400 of FIG. 4A clipped onto a conduit 424. Here it can be seen that the head 408 is slightly further back in the guide in the body 405, to accommodate the conduit 424. The conduit 424 is gripped between the first, second and third conduit engaging portions 404, 406, 410 and the third conduit engaging portion 410 is pressed against the conduit 424. In some examples the third conduit engaging portion 410 comprises a sensor, which is pressed securely against the surface of the conduit 424. Since the first and second conduit engaging portions 404, 406 fit behind the conduit, the force exerted by the biasing means 418 is resisted, thereby preventing the third conduit engaging portion 410 from moving further forwards. This arrangement provides good contact, which is beneficial for particular types of sensor, e.g. thermometers. In some cases, the sensor may not actually be exposed to the surface of the conduit 424 but is shielded by a suitable cover. For example, a temperature sensor can be mounted behind a high thermal conductivity shield, which is nevertheless rugged enough to protect the sensor. Metallic covers are appropriate for this role.

FIGS. 4C to 4G show the device 400 of FIGS. 4A and 4B in the process of gripping conduits 424 of various sizes. In FIG. 4C, the device 400 is in the second configuration in which the jaws 402 have been held at a wide spacing by an inward force exerted on the handles 430. This results in the jaws 402 being spaced widely enough to fit around a very large conduit 424. In this context, a “very large” conduit 424 is one that is approximately as large as the largest one which the device 400 is intended to accommodate.

With the conduit 424 located between the jaws 402, the handles 430 can be released and the first and second conduit engaging portions 404, 406 return towards their equilibrium position, engaging with the conduit 424 when they contact it.

In FIG. 4D, it can be seen that the head 408 remains relatively far back in the body 405 to accommodate the conduit 424. As a result, the spring 418 remains largely compressed. The arrangement in FIG. 4D is stable because the conduit 424 prevents the head 408 from sliding any further towards the first and second conduit gripping portions 404, 406, while the biasing means 418 prevents the head 408 from sliding away from the first and second conduit engaging portions 404, 406. In addition, the conduit engaging portions 404, 406 exert an inward force on the conduit 424 as they are forced towards their equilibrium position.

The device 400 of FIGS. 4A to 4D is shown gripping a large, small and very small conduit 424 in FIGS. 4E to 4G respectively. In this context, “large” means a conduit 424 which is towards the larger end of the range of conduits for which the device 400 is designed, but is by no means the largest. Likewise, “small” means a conduit 424 which is towards the smaller end of the range of conduits for which the device 400 is designed, but is by no means the smallest. “Very small” refers to a conduit 424 that is approximately as small as the smallest one which the device 400 is intended to accommodate.

Note that as the device 400 is used to grip yet smaller conduits 424, the head 408 moves further forwards (towards the conduit gripping portions 404, 406) under the action of the biasing means 418. Additionally, the jaws 402 come together to contact the smaller conduit 424 size, by virtue of their being biased towards a closed position. The jaws 402 are curved such that they only contact the conduit 424 over a small area, since the curvature of the jaws 402 does not match the curvature of the conduit 424 at the point of contact. In every case, there are three points of contact between the device 400 and the conduit 424, thereby providing a secure grip. In order to release the device 400 from the conduit, the handles 430 can once again be actuated by bringing them close to the body 405 and thereby opening the jaws 402. Once the device 400 is in this second configuration, the jaws 402 will be wide enough to fit over the conduit 424, and the device 400 can be easily removed from the conduit 424.

In FIG. 5A, yet a further example of a device 500 is shown. In this example, a first jaw 502a extends from a first conduit engaging portion 504, through a first clip 534a to a rear portion. Similarly, a second jaw 502b extends from a second conduit engaging portion 506, through a second clip 534b to the rear portion where it joins with the first jaw 502a. The jaws 502 are arranged such that the first and second conduit engaging portions 504, 506 are opposed to one another. The clips 534 are also opposed to one another and are joined together via a body 505. The body retains a head 508 in a fixed arrangement such that the head 508 and the body 505 cannot move independently of one another.

On an inner face of the first clip 534a is a first clip ratcheting portion 536a, configured to engage with a first jaw ratcheting portion 538a located on an outer surface of the first jaw 502a. Similarly, on an inner face of the second clip 534b is a second clip ratcheting portion 536b, configured to engage with a second jaw ratcheting portion 538b located on an outer surface of the second jaw 502b. The engagement of the jaw ratcheting portions 538 with the clip ratcheting portions 536 allows the clips 534 (and correspondingly, the head 508 and body 505) to be retained in a fixed location relative to the jaws 502.

Extending from a front end of the head 508 (the end closest to the first and second conduit engaging portions 504, 506), substantially aligned with the jaws 502, is a third conduit engaging portion 510. As shown, a conduit 524 is gripped between the three conduit engaging portions 504, 506, 510. The body 505 is slidable relative to the jaws 502 by disengaging the ratchet portions 536, 538 from one another. This allows the body 505, and thus the third conduit engaging portion 510, to be moved towards or away from the conduit 524 in order to grip or release it. Once the third conduit engaging portion 510 is in good contact with the conduit 524, the ratcheting portions 536, 538 can be re-engaged with one another, thereby locking the head 508, body 505 and third conduit engaging portion 510 in position and gripping the conduit 524 firmly. Extending from the rear end of the head 508 is a cable 522, for connecting the device to e.g. a processor or communications unit for processing or communicating measured data.

In some examples the third conduit engaging portion 510 comprises a sensor, which is pressed securely against the surface of the conduit 524 in the manner set out above. This arrangement provides good contact, which is beneficial for particular types of sensor, e.g. thermometers. In some cases, the sensor may not actually be exposed to the surface of the conduit 524 but is shielded by a suitable cover. For example, a temperature sensor can be mounted behind a high thermal conductivity shield, which is nevertheless rugged enough to protect the sensor. Metallic covers are appropriate for this role.

FIG. 5B shows the device 500 of FIG. 5A also clipped onto a conduit 524, but from a different angle. Here it can be seen that the clips 534 provide a pivoting point for the jaws 502 to flex around in order to widen the jaw spacing. In common usage of the device 500, the jaws 502 relax to a first configuration in which the first and second conduit engaging portions 504, 506 are close to one another. As set out below, the interaction between the jaws 502 and the clips 534 results in the jaws 502 being held in a second, open configuration, in which the first and second conduit engaging portions 504, 506 are stably held spaced widely apart.

FIGS. 5C to 5G show this effect in a very clear manner, in which the device 500 is shown at various stages of the process of gripping conduits 524 of various sizes. In FIG. 5C, the device 500 is in the second configuration in which the jaws 502 have been held at a wide spacing. This happens due to the shape of the jaws 502 and the clips 534. The clips 534 include a recess on the inner surface while the jaws 502 have a shoulder on their inner surface. When a shoulder engages with its corresponding recess in its clip 543, the jaw 502 is forced outwards, thereby increasing the separation of the first and second conduit engaging portions 504, 506. This effect is seen when a clip 534 is aligned with (i.e. gripping) a particular portion of its corresponding jaw 502, specifically the portion of the jaw 502 with the shoulder, which in the present example is a sudden thinning of the jaw body.

Since the ratcheting portions 536, 538 can engage to lock the position of the clips 534 relative to the jaws 502, the second configuration in which the jaws are widely spaced is a stable one. Consequently, a user can widen the jaws 502 by pulling the head 508 backwards until the shoulder engages with the recess and then locking the ratcheting portions 536, 538 to one another. With the jaws 502 wide, the device 500 can be fit over a conduit 524. Once in position, the device 500 can grip the conduit 524 by disengaging the ratcheting means 536, 538, sliding the head 508 towards the conduit 524 until the third conduit engaging portion 510 contacts the conduit 524. The ratcheting means 536, 538 can then be re-engaged with one another to lock the device 500 in place. Substantially the same procedure performed in reverse can be followed to remove the device 500 from the conduit 524.

In FIGS. 5D to 5G the device is shown gripping progressively smaller conduits 524, ranging from very large to very small. As above, in this context, a “very large” conduit 524 is one that is approximately as large as the largest one which the device 500 is intended to accommodate. A “large” conduit 524 is a conduit 524 which is towards the larger end of the range of conduits for which the device 500 is designed, but is by no means the largest. Likewise, “small” means a conduit 524 which is towards the smaller end of the range of conduits for which the device 500 is designed, but is by no means the smallest. “Very small” refers to a conduit 524 that is approximately as small as the smallest one which the device 500 is intended to accommodate.

Progressing through these Figures, note that as the device 500 is used to grip yet smaller conduits 524, the head 508 moves further forwards (towards the conduit gripping portions 504, 506), and is locked in place by the clip ratcheting portions 536 engaging with a different part (progressively further forward) of the jaw ratcheting portions 538. As the contact point between the clips 534 and the jaws 502 moves further forward on the jaws 502, the length of the jaw 502 protruding forwards from the clip 534 is reduced. Shorter jaw portions such as this represent a stiffer jaw which is more resilient to deformation. Consequently, the gripping power of the jaws 502 is increased when the head 508 slides towards the first and second conduit engaging portions 504, 506.

The jaws 502 are curved such that they only contact the conduit 524 over a small area, since the curvature of the jaws 502 does not match the curvature of the conduit 524 at the point of contact. In every case, there are three points of contact between the device 500 and the conduit 524, thereby providing a secure grip.

As will be clear to the skilled person, the features of the above examples can be applied to any other example. For example, the jaws of the device shown in FIGS. 2A to 2G can be actuated by handles such as those shown in FIGS. 4A to 4G, and the purpose of the grooves is simply to guide the head, and provide notches to hold the device in the second position. Similarly, the biasing means in FIGS. 2A to 2G or FIGS. 4A to 4G could be dispensed with and ratchets such as those in FIGS. 5A to 5G could be used to hold the head in place relative to the jaws. As another example, the forked conduit engaging portions 204a,b, 206ab,b, of FIGS. 2A and 2B can be applied to any of the designs in FIGS. 4 and 5. Similarly, the design in FIG. 2 need not have forked gripping portions 204, 206, but may grip the conduit 224 along a straight edge such as that shown in FIGS. 4 and 5.

Turning to FIG. 6, a housing 644 is shown, which connects to a cable 622. The other end of the cable to the housing is the device 200, 300, 400, 500 described above and shown in any of FIGS. 2 to 5. That is to say the cable 622 in FIG. 6 is an extension of any of the cables 222, 322, 422, 522 in FIGS. 2 to 5. The housing is configured to contain the processing or communication means for sensors provided with the devices shown in FIGS. 2 to 5. This allows data to be processed locally (e.g. for periodic retrieval), or to be transmitted elsewhere for processing or analysis. In addition, the housing may contain additional sensors, for example for measuring ambient properties such as temperature. The housing shown includes a control button 646 for controlling the processor, communication means, and/or sensor. For example, the button 646 may be used to reset one or more of these parts. Alternatively the button 646 may trigger transmission of stored data (e.g. wirelessly), or trigger a sensor to take an ambient measurement. In some examples there may be more than one button to allow a user a more fine grained interaction with the devices stored within the housing 644. In other examples, there may be no means by which a user can control the devices stored within the housing 644, or the means may be entirely provided by e.g. wireless communication, such that there is no need for external features such as buttons. The housing 644 may further be provided with a small screen, e.g. an LCD screen, to provide visual status updates to a user.

FIGS. 7A and 7B show an example of markings 150 for helping a user to identify whether a clip is correctly attached to a pipe. Here the markings 150 take the form of a band around the head 108 (although they could also be made on the cable 122, depending on the design of the clip). Where the head 108 is mounted in a housing, and slidable relative to the housing, the position of the band 150 relative to the housing allows a user to determine whether the clip is correctly attached to a pipe to which the clip has been attached.

FIG. 7C shows a series of four alternative markings 150 in detail. The top variant is a single band 152, similar to the markings 150 shown in FIGS. 7A and 7B. When the single band is suitably aligned with the housing, the user knows that the clip is optimally seated on the pipe. The next variant down has a pair of longitudinally (along the length of the cable) spaced bands 156. Once more, the user can check to see the positions of the bands 156, which indicate that the seating of the clip on the pipe is unacceptable. That is, if the gap between the bands 152 aligns with the housing, then the fit is optimal or at least acceptable, while if one of the markings 156 aligns with the housing, then the user knows an error has occurred in attaching the clip to the pipe. A third variant has a central marking 152 in a first colour, to indicate optimal attachment of the clip to the pipe. The central marking 152 is flanked by two markings 154 in a second colour, which indicate non-optimal, but still acceptable attachment of the clip to the pipe. If none of the three markings 152, 154 align with the housing, then the fit is unacceptable. The different colour of the two types of marking 125, 154 could be a completely different colour such as green for optimal, yellow for acceptable (or other high contrast arrangement). In other examples, the optimal marking 152 could be an intense variant of the colour (such as the black shown) while the acceptable marking 154 could be a faded variant (e.g. the grey colour shown). Indeed, the fourth variant shows just such a fading marking scheme, having an intense (black) region 152 in the centre, flanked by gradually fading regions 154 (through grey) to the colour of the cable 122 (white in this case). This allows a user to judge whether the attachment is sufficiently good to be acceptable.

FIGS. 7D and 7E show the cable 122 and head 108 shown in FIGS. 7A and 7B mounted in the body 170 of a clip. These Figures make clear the operation of the device. FIG. 7D shows the clip in its unmounted configuration. The head 108 is driven forwards (up in the Figure—towards the location where a pipe is intended to fit) by the action of a spring. As the head 108 is connected to the cable 122, being driven forwards pulls the cable into an aperture in the body 170 of the clip. Due to the marking 150 (in the form of a single band) being position a carefully chosen distance from the foremost part of the head 108, the head moves far enough to drag the entire band 150 into the housing 170, thereby obscuring the marking 150 from view. Conversely, FIG. 7E shows the clip in the ideal mounted position, where a pipe (not shown) has pushed the head 108 backwards (down in the Figure). This in turn pushes the cable 122 back out from the housing 170, and renders the marking 150 visible. Therefore, in order to check that the clip has correctly fit over the pipe, a user need only check to see whether the marking band 150 is visible. If the clip is mounted on a pipe, but the band 150 is not visible, then the user is alerted to a potential incorrect installation, and is motivated to try again.

FIGS. 7F and 7G show a variant of the markings 150 which can be used to alert a user to a correct (or incorrect) attachment to a pipe having one of a preselected set of sizes. These work on much the same principal as above, but with a plurality of markings 150, one for each preselected pipe size. A user can thereby feel confident that the clip has correctly attached to the pipe, even when the user may be required to fit the same type of clip to a variety of pipe sizes. As noted above, the variant in FIG. 7F works in the following manner: when a single band 150 corresponding to a particular pipe diameter is suitably aligned with the housing, the user knows that the clip is optimally seated on the pipe. The variant in FIG. 7G has pairs of longitudinally (along the length of the cable) spaced bands 150. Once more, the user can check to see the positions of the bands 150, which indicate that the seating of the clip on the pipe is unacceptable if a band aligns with the housing 170. That is, if the gap between the bands 150 aligns with the housing, then the fit is optimal or at least acceptable, while if one of the marking bands 150 aligns with the housing 170, then the user knows an error has occurred in attaching the clip to the pipe. It will be apparent that the any of the marking variants in FIG. 7C can be adapted to provide an indication in respect of multiple pipe sizes, by repeating (or combining) multiple instances of a particular marking 150, spaced longitudinally along the cable 122.

FIGS. 8A and 8B show a further variant of the markings 558 on a cable 522. In FIG. 8B, the cable is shown mounted in the clip 500 of FIGS. 5A to 5G, for which the same reference numerals have been used, and the operation of that clip 500 will not be repeated in detail here. These markings 558 take the form of a series of graduations (or a graduated scale), and allow a user to read out a numerical value relating to the position of the head 508. In the present example, the graduated scale 558 is marked in centimetres, but in other cases this can conveniently be presented in different units (millimetres, inches, eighths of an inch, etc.). These values can be calibrated to provide a readout of the diameter of pipe 524 to which the clip 500 is attached. A worker who installs many clips 500 will quickly become familiar with the various sizes of pipe 524 they encounter on a regular basis. A quick inspection of the pipe 524 prior to mounting the clip 500 can provide a reasonable estimate of the expected readout. Any deviation from this expected value can indicate to a user that the clip 500 has not been installed correctly, even if the point of attachment between the clip 500 and the pipe 524 is not visible to a user.

FIG. 8C shows a variant of the graduated scale 558 described above. As noted above, in practice a worker who is tasked with regularly installing such clips 500 will tend to notice that certain sizes of pipe 524 are more common than others. The graduated scale 558 in FIG. 8C takes advantage of this fact, and highlights certain common values for pipe sizes. In this case, while not to scale, the sizes are 11 mm, 15 mm, 22 mm and 33 mm, but these can vary based on local measurement systems (and common pipe sizes). In this example, while not shown, smaller ticks can be provided at non-standard pipe sizes (e.g. every millimetre as in FIG. 8A), to cover situations in which the installation team encounters a non-standard pipe size. In such cases, the team can measure the pipe 524 prior to fitting the clip 500, allowing a check of the readout once the clip 500 has been fitted to the pipe 524.

FIGS. 9A and 9B show another variant on the markings in which the markings take the form of a helix 160 on the outer surface of the cable 122. As is clear from FIG. 9A, when the cable 122 moves in or out of the housing 170 (through an aperture), the point at which the helix aligns with the housing (that is the furthest forward, or closest to the head, part of the helix which is visible) rotates around the aperture. The housing 170 has a marking 164 at a preselected location around the aperture which a user can use to determine whether the helix 160 aligns with the marking 164. It is a feature of helixes that the angular position and the linear position are intrinsically linked. This means that the angular position of the point where the helix 160 aligns with the housing is indicative of the lines position of the cable 122 (and consequently the linear position of the head).

As shown in FIG. 9B, the helix 160 is arranged to have a varying pitch 162. For example, a first pitch 162a is shorter than a second pitch 162b. This is chosen carefully so that parts on the helix 160 which align with a longitudinal line 163 on the cable 122 correspond to predetermined linear distances. The longitudinal line 163 corresponds in this case to the position of the marking 164 on the housing 170. As noted above, these distances can be chosen to correspond to commonly used pipe diameters. Line 163 may not actually be marked on the cable 122 in some examples, and is shown here simply to show the locations of the alignment of the helix with the marking 164 when the clip correctly grips various predetermined pipe sizes. This system allows a user to fit a clip to any one of a series of standard pipe sizes and the helix 160 will always align with a single marking 164 on the housing 170, so allowing the user to always ensure that the marking 164 is always visible by orienting the clip during the attachment process. Pipe sizes intermediate to these preselected pipe sizes will cause the helix 160 to align with the housing 170 at a different location to the marking 164.

The helix 160 may have longitudinal segments (not shown) at the locations corresponding to commonly used pipe sizes, which allows the cable 122 to be moved a small distance inwardly or outwardly relative to the housing 170 without causing the helix 160 to misalign with the marking 164. This provides a degree of tolerance in the measurement, in that if the pipe has been painted, it will be a little thicker than expected, but this should not affect the mounting process. In other words, the longitudinal segments help to weed out false negatives, which might otherwise cause a user to think that the clip was not attaching properly.

In some cases, the aperture may have a set of graduated markings showing the angular separation, e.g. a tick mark every 5°, with 45°, 90°, 135°, etc. clearly numbered, to allow a user to read out an angular reading. With knowledge of the pitch of the helix 160, the user can work out the position of the head 108, and thereby determine whether the clip has been correctly attached to the pipe (in a manner similar to that described above in respect of FIGS. 8A to 8C).

FIGS. 10A and 10B show another variant on the markings in which the markings take the form of a helix 160 on the outer surface of the cable 122. Similarly to FIGS. 9A and 9B, when the cable 122 moves in or out of the housing 170 (through an aperture), the point at which the helix aligns with the housing (that is the furthest forward, or closest to the head, part of the helix which is visible) rotates around the aperture. The housing 170 has a set of markings 164 around the aperture which a user can use to determine whether the helix 160 aligns with the marking 164. It is a feature of helixes that the angular position and the linear position are intrinsically linked. This means that the angular position of the point where the helix 160 aligns with the housing is indicative of the lines position of the cable 122 (and consequently the linear position of the head).

In contrast to FIGS. 9A and 9B, the helix 160 in FIGS. 10A and 10B is arranged to have a constant pitch 162. Pipes of different preselected diameters can be identified to a user by marking each of the markings 164 around the aperture with the pipe size to which they correspond.

Consider now FIG. 11, which shows an optical element 166 for clarifying which part of the cable 122 is aligned with the housing 170. As noted, the installation of clips can occur in difficult circumstances or at awkward angles. This can lead to it being difficult for a user to see which parts of the cable 122 are actually aligned with the housing 170. The arrangement in FIG. 11 has a reflective element 166 to allow a user to look substantially longitudinally along the cable 122 (line of sight 168). The reflective element 166 causes light reflected by the cable 122 to be reflected at approximately 90° to cause it to propagate broadly along the cable 122. Since this is the direction in which the user is looking, the user can clearly see the portion of cable 122 which is inside the aperture in the housing 170. This can help a user to determine whether the alignment of the markings 150 on the cable 122 with the housing 170 is within an acceptable range, or whether there is sufficient misalignment to suggest that a re-installation is required. In some cases, the optical element may include markings (similar to marking 164 of FIGS. 9A to 10B), which act like a crosshair to allow a user to align the markings with the casing. This may be particularly useful in the case of the helical markings 160 of FIGS. 9A to 10B.

An alternative example of the device in FIG. 11 is to use refraction to clarify the picture. A lens type structure can be designed which bends the light reflected from the cable such that a user sees the whole optical element take on the colour of the cable which is passing through the aperture. Thus, in cases such as those described in respect of FIGS. 7A to 7G, the user can see e.g. if the optical element shows green, meaning that the attachment of the clip to the pipe is optimal, yellow, indicating that the attachment is acceptable, or red indicating an unacceptable attachment.

1. A device for attaching a temperature sensor to a pipe, the device comprising:
a first jaw having a first engaging portion for contacting the pipe;
a second jaw opposed to the first jaw and having a second engaging portion for contacting the pipe; and
a head slidably mounted between the jaws and having a third engaging portion for contacting the pipe and for retaining a first temperature sensor, the head being moveable between a closed position and an open position, in which the third engaging portion is closer to the first and second engaging portions in the closed position than in the open position; wherein
the jaws are moveable between closed and open configurations, in which the first and second engaging portions are closer to one another in the closed configuration than in the open configuration; wherein
motion of the jaws and the head is coupled so that the open configuration of the jaws corresponds to the open position of the head and the closed configuration of the jaws corresponds to the closed position of the head; and wherein
the device is arranged to bias the first temperature sensor against the pipe in the closed configuration.

2. The device of claim 1, further comprising means for selectively retaining the jaws in the open configuration and the head is biased towards the closed position such that selectively releasing the jaws returns the jaws to the closed configuration.

3. (canceled)

4. A device according to claim 1, wherein the head is mounted between the first and second jaws by means of guidance means, wherein the guidance means couples the movement of the head to the movement of the jaws.

5.-7. (canceled)

8. A device according to claim 4, wherein the guidance means is configured to draw the jaws towards the first configuration in the event that the head moves from the open position to the closed position.

9.-15. (canceled)

16. A device for attaching a temperature sensor to a pipe, the device comprising:
a first jaw having a first engaging portion for contacting the pipe;
a second jaw opposed to the first jaw and having a second engaging portion for contacting the pipe; and
a head mounted between the jaws having a third engaging portion for contacting the pipe; wherein
the jaws are moveable between closed and open configurations, in which the first and second engaging portions are closer to one another in the closed configuration than in the open configuration; wherein
the jaws are biased towards the closed configuration; and wherein
the device further comprises means for retaining the jaws in the open configuration.

17. The device of claim 16 further comprising means for sliding the head relative to the jaws between a closed position and an open position, in which the third engaging portion is closer to the first and second engaging portions in the closed position than in the open position.

18. A device according to claim 17, wherein the head is mounted between the jaws by a first clip which grips the first jaw and a second clip which grips the second jaw.

19. A device according to claim 18, wherein the means for sliding the head comprise the first and second jaws being slidable through their respective clips.

20.-23. (canceled)

24. A device according to claim 1, further comprising the first temperature sensor retained in the third engaging portion.

25. A device according to claim 1, further comprising a processing unit.

26. A device according to claim 25, wherein the processing unit is connected to the head via a cable.

27. A device according to claim 26, wherein:
the jaws form part of a body;
the head includes the first temperature sensor and the first temperature sensor has a cable connected thereto, the cable extending away from the head and through an aperture in the body; wherein
the head is slidably mounted to the body such that the head, sensor and cable are slidably moveable relative to the body; and wherein
the cable is provided with a marking system for indicating to a user whether the device is correctly attached to the pipe.

28.-47. (canceled)

48. A clip for attaching a sensor to a pipe, comprising:
a body having at least one engaging portion for gripping the pipe;
a head for engaging the pipe;
a sensor for measuring a property of the pipe or a fluid within the pipe, the sensor being received in the head and having a cable connected thereto, the cable extending away from the head and through an aperture in the body; wherein
the head is slidably mounted to the body such that the head, sensor and cable are slidably moveable relative to the body; and wherein
the cable is provided with a marking system for indicating to a user whether the device is correctly attached to the pipe.

49. A clip according to claim 48, wherein the marking system indicates to a user the position of the head relative to the body.

50. A clip according to claim 48, wherein the clip is arranged to bias the sensor against the pipe.

51.-54. (canceled)

55. A clip according to claim 48, wherein the marking system comprises a series of graduations.

56. (canceled)

57. A clip according to claim 48, wherein the marking system comprises a helix extending around and along the cable and a marking around the edge of the aperture.

58. A clip according to claim 57, wherein the helix has a constant pitch and the aperture on the body has a series of angularly spaced markings around the edge of the aperture, wherein each of the angularly spaced markings corresponds to a different pipe diameter.

59. A clip according to claim 57, wherein the helix has a varying pitch such that a single longitudinal line on the surface of the cable intersects the helix at a series of positions corresponding to attachment of the clip to a pipe having a standard pipe diameter.

60. (canceled)

61. A clip according to claim 48, wherein the body includes an optical element adjacent to the aperture, for viewing the section of cable adjacent to or within the aperture.

62. (canceled)
